(19) United States
(12) Patent Application Publication
(10) Pub. No.: US 2014/0309379 A1
(43) Pub. Date: Oct. 16, 2014

(54) POLYSILOXANE-MODIFIED POLYLACTIC ACID COMPOSITION, COMPOSITION UTILIZING SAME, MOLDED ARTICLE, AND PRODUCTION METHOD

(71) Applicants: Makoto SOYAMA, Minato-ku (JP); Akinobu NAKAMURA, Minato-ku (JP); Masatoshi IJI, Minato-ku (JP)

(72) Inventors: Makoto SOYAMA, Minato-ku (JP); Akinobu NAKAMURA, Minato-ku (JP); Masatoshi IJI, Minato-ku (JP)

(73) Assignee: NEC CORPORATION, Tokyo (JP)

(21) Appl. No.: 14/313,526

(22) Filed: Jun. 24, 2014

Related U.S. Application Data
(63) Continuation of application No. 13/254,771, filed on Sep. 2, 2011.

(30) Foreign Application Priority Data
Mar. 6, 2009 (JP) 2009-053175

(51) Int. Cl. C08G 63/91

(52) U.S. Cl. CPC C08G 63/912
USPC 525/450

(57) ABSTRACT

Disclosed are a polysiloxane-modified polylactic acid resin, composition using same, molded article, and production method, whereby it is possible to produce a molded article via a simple method, and where said article may be used in applications demanding a high level of impact resistance as an alternative to ABS resin or the like, has a similar level of impact resistance as said substances, has superior flexibility with respect to rupture bending strain and tensile breaking strain, and has bleed resistance. The polysiloxane-modified polylactic acid resin has a segment which is a polylactic acid compound, and a segment which is an amino polysiloxane compound which has an amine group. With respect to the amino poly-siloxane compound, amine groups are on average contained in the range of 0.01 to 2.5% inclusive by mass, and with respect to the polylactic acid compound, are on average contained in the range of 3 to 300 ppm inclusive by mass.

### FIELD OF THE INVENTION

This application is a Continuation of U.S. application Ser. No. 13/254,771 filed Sep. 2, 2011, which is a National Stage of PCT/JP2010/053819 filed Mar. 8, 2010, which claims the benefit of priority of Japanese patent application no. 2009-053175, filed Mar. 6, 2009, the disclosures of which are incorporated by reference in their entirety. The present invention relates to a polysiloxane-modified polylactic acid resin having high levels of impact resistance, flexibility with respect to rupture bending strain and tensile breaking strain, and bleed resistance; a composition using the same; a molded article using the same; and methods for production thereof.

### BACKGROUND OF THE INVENTION

Polyhydroxy carboxylic acids including polylactic acids have been known as having excellent properties such as relatively high levels of moldability, toughness and stiffness. Among these, polylactic acids may be synthesized using natural materials such as maize, and have excellent moldability and biodegradability, and thus they have been developed for use in various areas as eco-friendly resins. Although polylactic acids have excellent properties as stated above, impact resistance or flexibility with respect to rupture bending strain or tensile breaking strain is lower than petroleum-derived resins such as ABS resins. Thus, polylactic acids have a disadvantage that they may not be used as exterior finishing materials for electric or electronic devices requesting high impact resistance.

It has been made an attempt to impart impact resistance to a molded product obtained from such polylactic acid resin compositions. For example, Patent Document 1 reports biodegradable resin compositions containing polylactic acids and other biodegradable resins, and further silicon-based additives and lactic acid polyesters, which have good impact resistance and are preferably used in electronic or electric devices. However, since these degradable resins contain a large amount of silicon-based additives, surface bleed may be generated over time. If the amount of silicone-based additives is decreased to avoid such surface bleed, it is difficult to obtain a molded product having impact resistance.

Also, Patent Document 2 reports a molded product of polylactic acid resin containing organic polysiloxanes such as silicone oils, thereby having both impact resistance and thermal resistance. However, silicone oils have poor compatibility with polylactic acids, and thus silicone oils may be bled into the surface of a molded product during or after forming, resulting in degrading the properties of the molded product and lacking utilization.

In addition, Patent Document 3 reports biodegradable resin compositions containing polylactic acids and copolymers of silicones and lactic acids, thereby having good impact resistance and flame retardancy. However, in cased of these compositions, flame retardancy is good, but impact resistance is insufficient compared to resins which are generally used in electronic or electric devices. Further, the process for producing copolymers of silicones and lactic acids are complicated. Therefore, it is difficult to apply these compositions to practical applications.

Additionally, Patent Document 4 reports lactic acid polymer compositions containing organic silicon compounds and inorganic fillers (nucleating agents) as polymers having both impact resistance and thermal resistance, and also Patent Document 5 reports polylactic acid resin compositions containing polyhydroxy carboxylic acid structure units, polyester block copolymers of particular dicarboxylic acids and diols, polylactic acids and particular siloxane compounds, these polylactic acid compositions having impact resistance, transparency and bleed resistance. However, a molded product obtained from these compositions has improved impact resistance, but does not satisfy a level required for electronic or electric devices.

There is a need for polylactic acid resins which have impact resistance equivalent to ABS resins, may be used as the alternative to ABS resins in application requesting high impact resistance, do not exhibit surface bleed, and may be produced by a simple process.

### PRIOR ART DOCUMENTS

Patent Documents

Patent Document 1: JP Patent Application Publication No. 2004-161790

Patent Document 2: JP Patent Application Publication No. Hei 11-116786

Patent Document 3: JP Patent Application Publication No. 2004-277575

Patent Document 4: JP Patent Application Publication No. 2004-352908

Patent Document 5: JP Patent Application Publication No. 2007-262200

### SUMMERY OF THE INVENTION

It is an objective of the present invention to provide polysiloxane-modified polylactic acid resins which have impact resistance equivalent to ABS resins, available as the alternative to ABS resins in application requesting high impact resistance, and good flexibility to rupture bending strain or tensile breaking strain, compositions using the same, a molded product, and production methods thereof. By using such polysiloxane-modified polylactic acid resins according to the present invention, a molded product having bleed resistance may be produced by a simple process.

The present inventors have eagerly studied to improve the impact resistance, the flexibility to rupture bending strain or tensile breaking strain, and the bleed resistance of polylactic acid resins. As a result, it has been found that polylactic acid resins having the segment of polysiloxane compounds obtained by reacting polysiloxane compounds having amino group on at least some of its side chains and polylactic acid resins at a particular ratio have excellent impact resistance, the flexibility to rupture bending strain or tensile breaking strain, and the bleed resistance. In addition, it has been found that polylactic acid resin compositions obtained by blending polysiloxane compounds having epoxy groups with polylactic acid resins having the segment of polysiloxane compounds obtained by reacting polysiloxane compounds having amino group on at least some of its side chains and poly-lactic acid resins at a particular ratio have more excellent impact resistance, the flexibility to rupture bending strain or tensile breaking strain, and the bleed resistance. Thus, the present invention has been completed on the basis of these findings.

Accordingly, the present invention relates to a polysiloxane-modified polylactic acid resin having a segment of a polylactic acid compound, and a segment of an amino-containing polysiloxane compound having an amino group, wherein the amino group is on average contained in the range of 0.01 to 2.5% inclusive by weight with respect to the amino-containing polysiloxane compound, and is on average contained in the range of 3 to 300 ppm inclusive by weight with respect to the polylactic acid compound.

It is another objective of the present invention to provide polysiloxane-modified polylactic acid resin compositions which contain at least one of said polysiloxane-modified polylactic acid resins, or polysiloxane-modified polylactic acid resin compositions which are obtained by mixing and stirring at least one selected from amino-containing polysiloxane compounds and melted polylactic acid compounds.

It is still another objective of the present invention to provide a method for producing polysiloxane-modified polylactic acid resin compositions comprising mixing and stirring at least one selected from amino-containing polysiloxane compounds and melted polylactic acid compounds.

It is further objective of the present invention to provide a molded product which is obtained using at least one of said polysiloxane-modified polylactic acid resins and said poly-siloxane-modified polylactic acid resin compositions.

As reasons that such polysiloxane-modified polylactic acid resins have very good mechanical properties such as impact resistance, and high surface bleed inhibiting effect, it may be contemplated that polysiloxane compounds having amino groups are reacted with ester groups in polylactic acid resins to form polysiloxane polylactic acid copolymers through amide linkages. In principle, polylactic acid resins and polysiloxane compounds do not have compatibility for each other, leading to dispersion failure or surface bleed. However, poly-siloxane polylactic acid copolymers in which a particular amount of polysiloxane segments are introduced in polylactic acid resins may be formed by polymerization of polysiloxane compounds having a particular amount of amino groups and polylactic acid compounds, and these copolymers are dispersed very well in polylactic acid resins to form elastomer particles which are capable of binding well to interfaces with polylactic acid resins. Thus, by using these resins, it is believed that good impact resistance and flexibility to rupture bending strain or tensile breaking strain, as well as bleed resistance may be imparted to a molded product. In addition, by blending epoxy-containing polysiloxane compounds with said polysiloxane polylactic acid copolymers, since more strong silicone elastomer particles are formed in polysiloxane polylactic acid copolymers, or plasticity is imparted to these copolymers, it is believed that a molded product may have more excellent impact resistance or mechanical flexibility.

The polysiloxane-modified polylactic acid resin according to the present invention can be produced by a simple process. Also, the resin has impact resistance equivalent to ABS resins, available as the alternative to ABS resins in application requesting high impact resistance, and good flexibility to rupture bending strain or tensile breaking strain. By using the resin according to the present invention, a molded product having bleed resistance can be obtained. In addition, when producing or discarding such a molded product, environmental burden can be reduced.

### BRIEF DESCRIPTION OF THE INVENTION

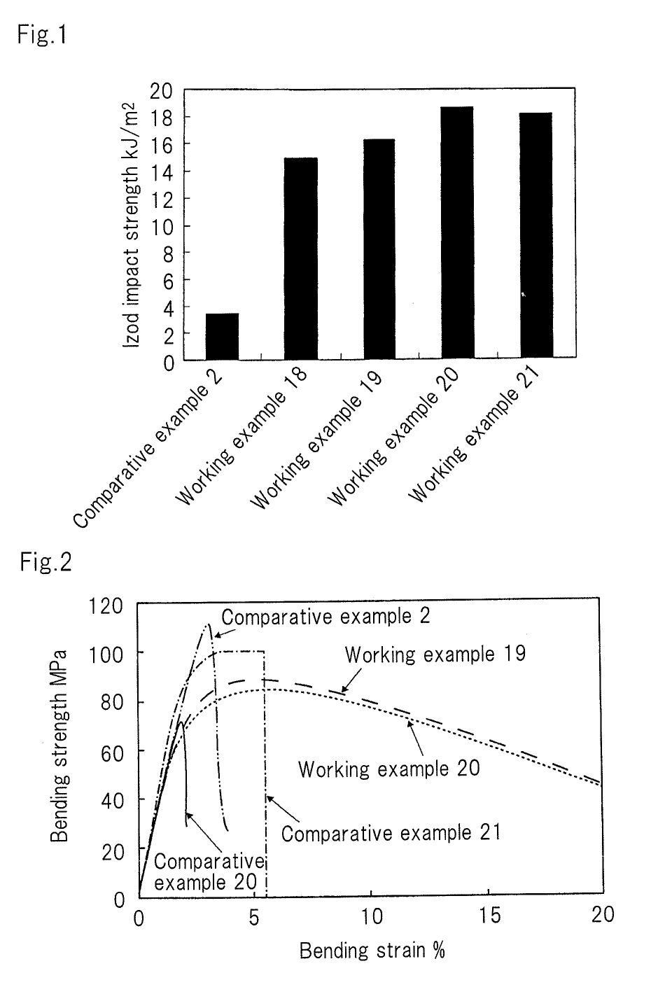

FIG. 1 is a view showing the impact property of polysiloxane-modified polylactic acid resin compositions according to this invention.

FIG. 2 is a view showing the bending property of polysiloxane-modified polylactic acid resin compositions according to this invention.

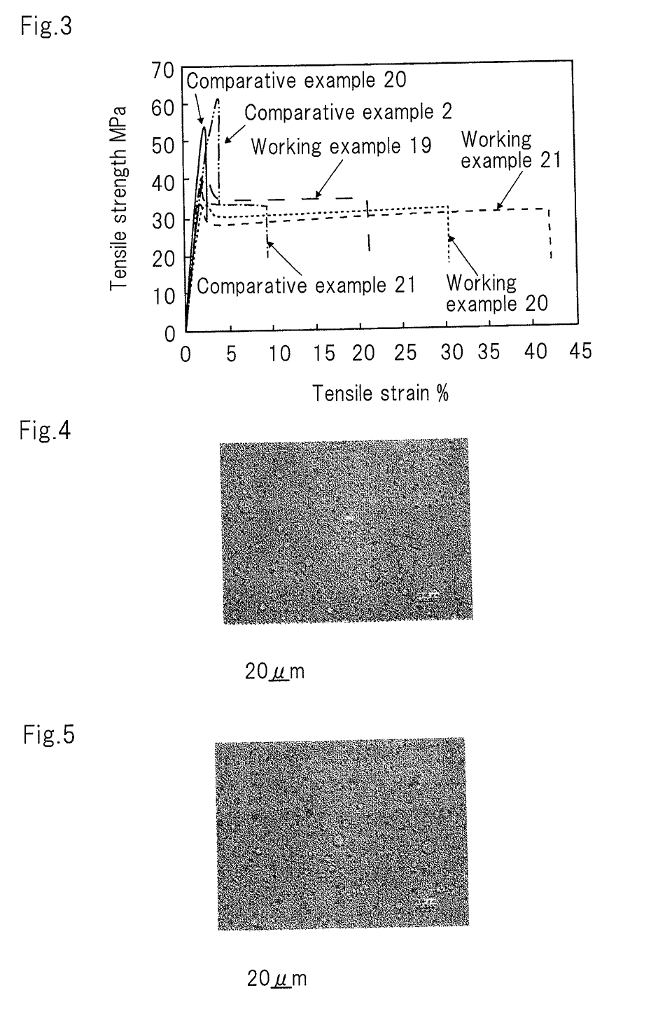

FIG. 3 is a view showing the tensile property of polysiloxane-modified polylactic acid resin compositions according to this invention.

FIG. 4 is a view showing the optical microscopic image of the polysiloxane-modified polylactic acid resin composition from Working Example 19 according to this invention.

FIG. 5 is a view showing the optical microscopic image of the polysiloxane-modified polylactic acid resin composition obtained from Working Example 20 of this invention.

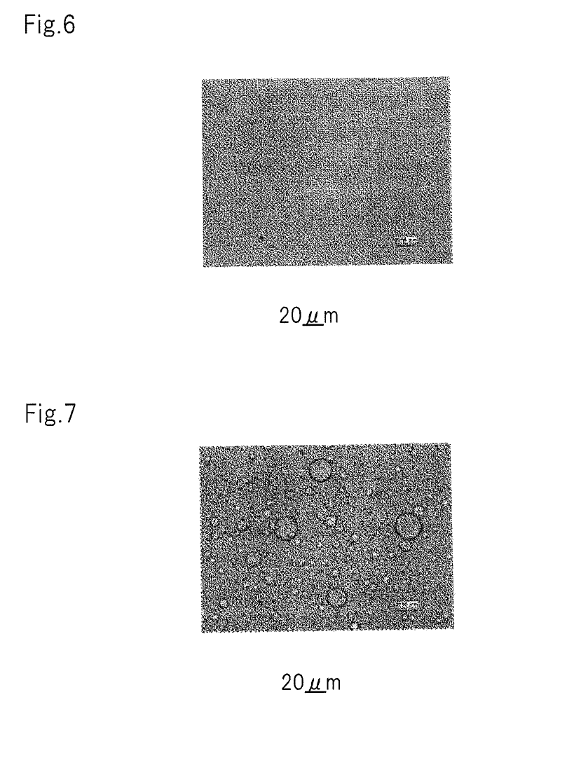

FIG. 6 is a view showing the optical microscopic image of the polysiloxane-modified polylactic acid resin composition obtained from Comparative Example 20 of this invention.

FIG. 7 is a view showing the optical microscopic image of the polysiloxane-modified polylactic acid resin composition obtained from Comparative Example 21 of this invention.

### DETAILED DESCRIPTION OF THE INVENTION

According to the present invention, the polysiloxane-modified polylactic acid resin is characterized by having a segment of a polylactic acid compound, and a segment of an amino-containing polysiloxane compound having an amino group, wherein the amino group is on average contained in the range of 0.01 to 2.5% inclusive by weight with respect to the amino-containing polysiloxane compound, and is on average contained in the range of 3 to 300 ppm inclusive by weight with respect to the polylactic acid compound.

Examples of the segment of the polylactic acid compound used in the polysiloxane-modified polylactic acid resin according to this invention may include extracts of polylactic acid compounds derived from biomass materials or derivatives or variants thereof, or products obtained by polycondensation using monomers or oligomers of lactic acid compounds derived from biomass materials or derivatives or variants thereof, as well as segments of polylactic acid compounds synthesized from materials other than biomass materials. As an example of the polylactic acid compound forming such segments, there is a compound represented by the following formula (27):

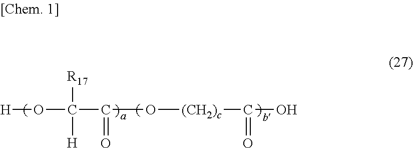

in the formula (27), R₁₇ represents an alkyl group having 1˜18 carbon atoms; a and c are an integer greater than 0; and b′ is an integer greater than or equal to 0. Preferably, a is an integer of 500˜13000 inclusive, and more preferably an integer of 1500˜4000 inclusive. Preferably, b′ is an integer of 0˜5000 inclusive, and c is an integer of 1˜50 inclusive. In a polylactic acid compound represented by the formula (27), repetitive units may be repeated by the repetitive number a, and b of the repetitive units, and the same repetitive unit may be continuously positioned or may be alternately positioned. Typically, examples of polylactic acid compounds represented by the formula (27) may include L-lactic acids, D-lactic acids, polymers of derivatives thereof, as well as copolymers containing said compounds as a main component. Examples of such copolymers may include copolymers of L-lactic acids, D-lactic acids and derivatives thereof, and one or two or more compounds, for example, selected from glycolic acids, polyhydroxy butyric acids, polycaprolactones, polybutylene succinates, polyethylene succinates, polybutylene adipate terephthalates, polybutylene succinate terephthalates, and polyhydroxy alkanoates. Among these, materials derived from plants may preferably be used as a raw material for saving petroleum resource, and in particular poly(L-lactic acids), poly(D-lactic acids), or copolymers thereof may preferably be used for thermal resistance or moldability. Moreover, polylactic acids having poly(L-lactic acid) as a main component have various melting points depending on the ratio of D-lactic acid component. For the mechanical properties or thermal resistance of a molded product, the melting point is preferably 160° C. or more.

Preferably, polylactic acid compounds have the molecular weight of 30000˜1000000 inclusive, and more preferably 100000˜300000 inclusive.

Examples of the segment of the amino-containing polysiloxane compound used in the polysiloxane-modified polylactic acid resin may include compounds having amino groups. The amino group reacts with an ester group in the segment of the polylactic acid compound, and forms the segment of polysiloxane compound coupled to the polylactic acid compound through an amide linkage. Thus, the separation of the polysiloxane compound and the bleed of the separated polysiloxane compound may be inhibited, and a molded product having high impact strength may be formed. Further, the amino group is preferably linked to a side chain of polysiloxane compound. The amino-containing polysiloxane compound having an amino group at its side chain may easily adjust the concentration of the amino group and the reaction of this compound with the segment of the polylactic acid compound, thereby enhancing the effect stated above. Moreover, it is in particular preferred that the amino group is a diamino group, since the diamino group has higher reactability to the polylactic acid compound than a monoamino group.

In the amino-containing polysiloxane compound, an average content of the amino group should be within the range capable of maintaining the reactability to the segment of the polylactic acid compound, while increasing the molecular weight of the amino-containing polysiloxane compound and inhibiting the volatility of the amino-containing polysiloxane compound during manufacturing processes. To this end, the content of the amino group is on average 0.01˜2.5% by weight inclusive, and preferably on average 0.01˜1.0% by weight inclusive. If the content is on average 0.01% by weight or more, an amide linkage to the segment of the polylactic acid compound may sufficiently be formed, an effective production is possible, and the bleed of a separated polysiloxane segment in a molded product may be inhibited. If the content is on average 2.5% by weight or less, the hydrolysis of the polylactic acid compound may be inhibited during manufacturing processes, and an aggregation may be inhibited, thereby obtaining a molded product having high mechanical strength and uniform composition.

The content of the amino group in the amino-containing polysiloxane compound may be calculated as an average content of the amino group in a polysiloxane compound using the following Equation (22).

Average content of an amino group in a polysiloxane compound (%)=(16/amino equivalent)×100 (22)
in the Equation (22), the amino equivalent is an average of the weight of an amino-containing polysiloxane compound per 1 mole amino group.

Further, the amount of the amino group with respect to the polylactic acid compound is within the range of 3˜300 ppm by weight inclusive. If the amount is 3 ppm by weight or more, the impact resistance of a molded product may be increased by virtue of the segment of the amino-containing polysiloxane compound. If the amount is 300 ppm by weight or less, the polylactic acid compound and the amino-containing polysiloxane compound may easily be dispersed during manufacturing processes, and a significant decrease of the molecular weight of the resulting polysiloxane-modified polylactic acid resin may be inhibited, thereby forming a molded product having excellent mechanical properties, for example high impact strength.

The amount of the amino group with respect to the polylactic acid compound may be calculated using the following Equation (23).

The amount of the amino group with respect to the polylactic acid compound (ppm by weight)=Average content of amino group (% by weight) in an amino-containing polysiloxane compound×Average weight of an amino-containing polysiloxane compound with respect to a polylactic acid compound (% by weight)×100 (23)

Preferably, the segment of the amino-containing polysiloxane compound may easily be coupled to the segment of the polylactic acid compound under a mild condition without using a particular means. As examples of the amino-containing polysiloxane compound, there are compounds represented by the following Formulas (1) or (2).

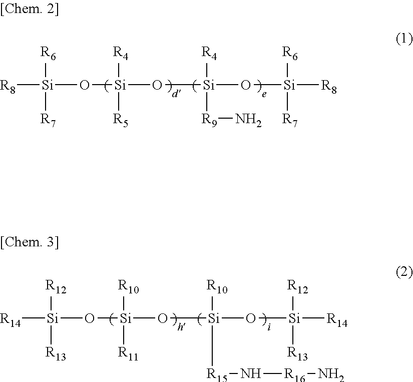

in the Formulas (1) and (2), R₄˜R₈ and R₁₀˜R₁₄ represent independently an alkyl group, an alkenyl group, an aryl group, an aralkyl group, an alkylaryl group having 1˜18 carbon atoms, or —(CH₂)_{α}—NH—C₆H₅ (α represents an integer of 1˜8). Preferably, the alkyl group is methyl, ethyl, propyl, butyl, or t-butyl group, the alkenyl group is vinyl group, the aryl group is phenyl, or naphthyl group, and the alkylaryl group is benzyl group. Further, an anilino group represented by —(CH₂)_{α}—NH—C₆H₅ is preferably included, where a represents an integer of 1˜8. Moreover, these groups may be entirely or partially substituted with halogen atoms such as chlorine, fluorine, or bromine. Typically, examples of groups having halogen substituents may include chloromethyl group, 3,3,3-trifluoromethyl group, perfluorobutyl group, or perfluoro-octyl group. R₄˜R₈ and R₁₀˜R₁₄ may be all the same or may be different one another, and it is in particular preferred that they are methyl group or phenyl group.

The phenyl group acts to improve the transparency of the polysiloxane compound segment. The content of phenyl group may be adjusted to control the refractive index of the resulting polysiloxane-modified polylactic acid resin. The refractive index of the polysiloxane compound segment may be matched with the index of the polylactic acid compound segment, thereby achieving a uniform refractivity in a molded product, as well as imparting a desired transparency to a molded product.

In the Formulas (1) and (2), R₉, R₁₅ and R₁₆ represent independently a divalent organic group. Examples of the divalent organic group may include alkylene groups such as methylene group, ethylene group, propylene group, or butylene group; alkylarylene groups such as phenylene group or tolylene group; oxyalkylene groups or polyoxyalkylene groups such as —(CH₂—CH₂—O)_{b}— (b is an integer of 1˜50), —[CH₂—CH(CH₃)—O]_{c}— (c is an integer of 1˜50); or —(CH₂)_{d}—NHCO— (d is an integer of 1˜8). It is in particular preferred that R₁₆ is ethylene group, and R₉ and R₁₅ are propylene group.

In the Formulas (1) and (2), d′ and h′ are an integer greater than or equal to 0, and e and i are an integer greater than 0. Preferably, they have mean values such that a number average molecular weight of the polysiloxane compound can satisfy the range as indicated below. Preferably, d′ and h′ are an integer of 1˜15000 inclusive, more preferably an integer of 1˜400 inclusive, and still more preferably 1˜100 inclusive. Also, e and i have the range of 1˜15000 inclusive. Additionally, an average content of an amino group in the amino-containing polysiloxane compound represented by the Formula (22) is preferably an integer within the range of 0.01˜2.5% by weight inclusive.

In the amino-containing polysiloxane compounds represented by the Formulas (1) and (2), the repetitive units each may be repeated by the repetitive number d′, h′, e, and i of the repetitive units, respectively, and the same repetitive unit may be continuously positioned or may be alternately positioned, or the repetitive units may be randomly positioned.

Preferably, a number average molecular weight of the amino-containing polysiloxane compounds is preferably 900˜120000 inclusive. If the number average molecular weight of the amino-containing polysiloxane compound is 900 or more, the volatilization and loss of the compound may be inhibited when blending with a melted polylactic acid compound during manufacturing a polysiloxane-modified polylactic acid resin. If the number average molecular weight is 120000 or less, the compound has good dispersibility, thereby obtaining a uniform molded product. The number average molecular weight of the amino-containing polysiloxane compound is more preferably 900˜30000 inclusive, and still more preferably 900˜8000 inclusive.

A measurement obtained from GPC (calibration with polystyrene standard sample) analysis using 0.1% solution in chloroform as a sample may be used as a number average molecular weight.

Preferably, the segment of said amino-containing polysiloxane compound includes segments comprised of reacted products of an amino-containing polysiloxane compound with an epoxy-containing polysiloxane compound having an epoxy group. As examples of the epoxy-containing polysiloxane compound forming such segment, typically, epoxy-containing polysiloxane compounds represented by the following Formula (12), or (19)˜(21) may preferably be used.

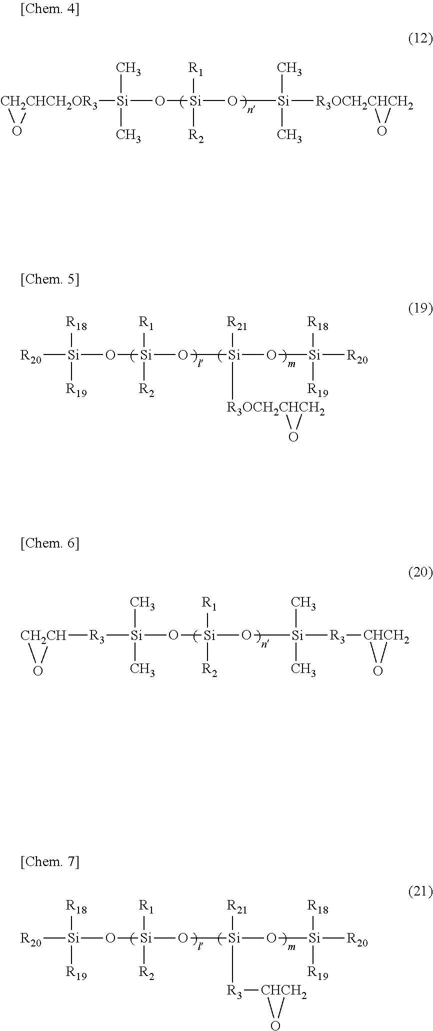

in the Formulas (12), or (19)˜(21), R₁, R₂ and R₁₈˜R₂₁ represent independently an alkyl group, an alkenyl group, an aryl group, an aralkyl group, an alkylaryl group having 1˜18 carbon atoms, or —(CH₂)_{α}—NH—C₆H₅ (α represents an integer of 1˜8), wherein these groups may be entirely or partially substituted with halogen atoms. R₃ represents a divalent organic group. l′ and n′ are an integer greater than or equal to 0, and m is an integer greater than 0. As an alkyl group, an alkenyl group, an aryl group, an aralkyl group, an alkylaryl group having 1˜18 carbon atoms, or —(CH₂)_{α}—NH—C₆H₅ represented by R₁, R₂ or R₁₈˜R₂₁, those listed for R₄ and others in the Formula (1) may be included. As R₃, those listed for R₉ and others in the Formula (1) may be included.

Further, for the epoxy-containing polysiloxane compounds (D2) represented by the Formula (19) or (21), an average content of the epoxy group is preferably less than 2% by weight. If the content of the epoxy group is less than 2% by weight, the reaction of the compound with an amino-containing polysiloxane compound may be controlled, and a properly cross-linked elastomer may be formed, thereby obtaining a molded product having improved mechanical properties.

For a reason in manufacturing processes, a number average molecular weight of the epoxy-containing polysiloxane compound is preferably 900˜120000 inclusive, as with said amino-containing polysiloxane compound.

An average content of an epoxy group in the epoxy-containing polysiloxane compound may be calculated using the following Equation (24).

Average content of an epoxy group in a polysiloxane compound (%)=(43/epoxy equivalent)×100 (24)

in the Equation (24), the epoxy equivalent is the weight of polysiloxane compound per 1 mole epoxy group.

Preferably, the content of the epoxy-containing polysiloxane compound forming said segment of the amino-containing polysiloxane compound is within the range of 0˜10% by weight inclusive with respect to the polylactic acid compound segment. If the content of the epoxy-containing polysiloxane compound is 10% by weight or less, the bleed of the residual epoxy-containing polysiloxane compound which does not react with an amino group may be inhibited in a molded product.

The segment of said amino-containing polysiloxane compound may include segments of polysiloxane compounds having an amino group at either end of its backbone, as long as the functions of said amino-containing polysiloxane compound is not inhibited, and further the resulting polysiloxane-modified polylactic acid resin may contain a polysiloxane compound segment having no amino group. Preferably, the contents of the polysiloxane compound having an amino group at either end of its backbone and the polysiloxane compound segment having no amino group is 0˜5% by weight inclusive of said amino-containing polysiloxane compound, and a number average molecular weight thereof is preferably 900˜120000 inclusive.

When producing such a polysiloxane-modified polylactic acid resin, a pre-prepared amino-containing polysiloxane compound and polylactic acid compound may be added at the desired ratio, and they may be stirred and mixed in a melted state under shearing force to form said polysiloxane-modified polylactic acid resin. Also, when the polysiloxane compound segment is comprised of a reacted product of an amino-containing polysiloxane compound and an epoxy-containing polysiloxane compound, the amino-containing polysiloxane, epoxy-containing polysiloxane, and polylactic acid compounds may be simultaneously added while stirring and mixing, but preferably the amino-containing polysiloxane and polylactic acid compounds are first reacted, and subsequently the epoxy-containing polysiloxane compound is reacted. The shearing force may be applied to the melted polylactic acid and amino-containing polysiloxane compounds using devices such as a roll, an extractor, a kneader, and a batch mixer with a condenser. To promote the feeding of feedstock and the recovery of a product, an extractor with uniaxial or multiaxial bents may preferably be used. A shearing temperature is above a melting flow temperature of polylactic acid compound. Preferably, a shearing temperature is 10° C. above the melting flow temperature and below a decomposition temperature. Preferably, a melting shearing time is, for example above 0.1 min and below 30 min, more preferably above 0.5 min and below 10 min. If the melting shearing time is above 0.1 min, the polylactic acid and the amino-containing polysiloxane compounds may be sufficiently reacted. If the melting shearing time is below 30 min, the decomposition of the resulting polysiloxane-modified polylactic acid resin may be inhibited.

The polylactic acid compound used may be produced using a melt polymerization method. Alternatively or additionally, a solid polymerization method may be used. When the melt flow rate of polylactic acid compound is too high, to adjust the melt flow rate of polylactic acid compound to a desired range, a small amount of a chain extending agent such as diisocyanate compounds, epoxy compounds or acid anhydrides may be used to increase the molecular weight of the resin. When the melt flow rate is too low, biodegradable polyester resins having high melt flow rate or low molecular weight compounds may be mixed.

As examples of the polysiloxane-modified polylactic acid resin according to the present invention, there are compounds represented by the following Formulas (3)˜(5), (8), (11), or (13)˜(18).

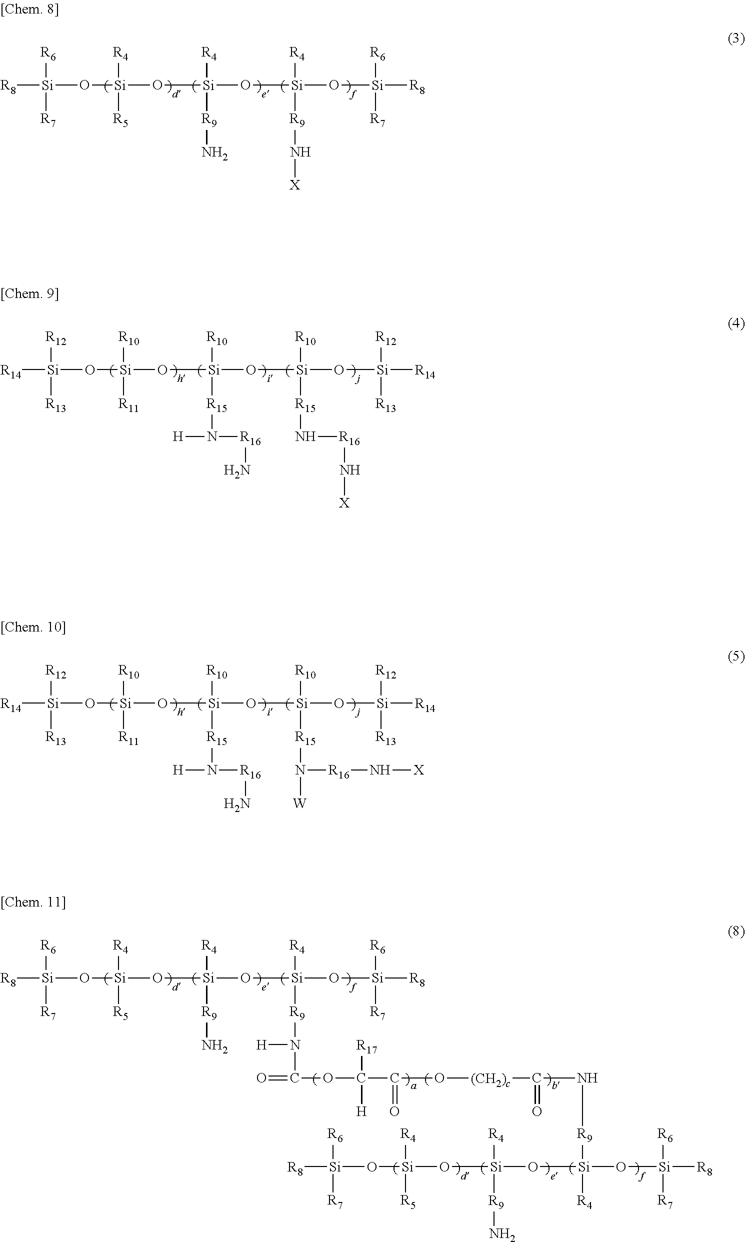

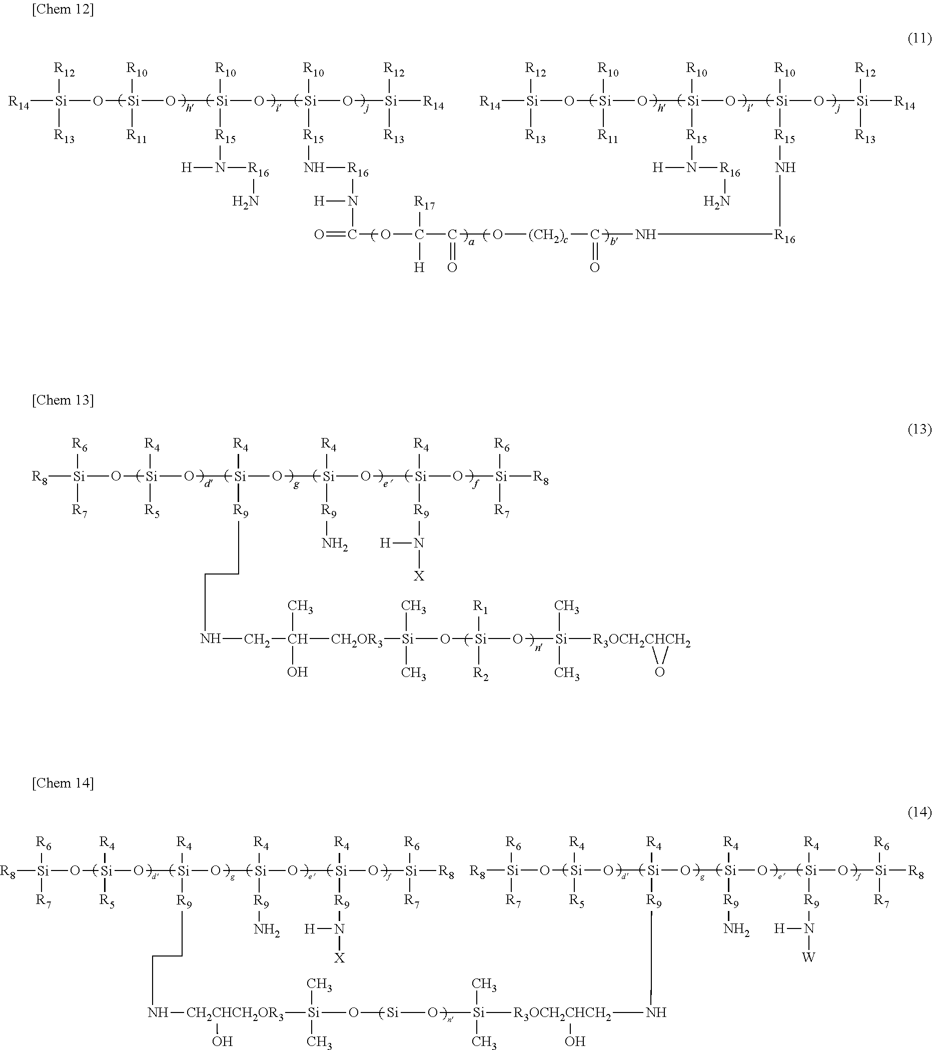

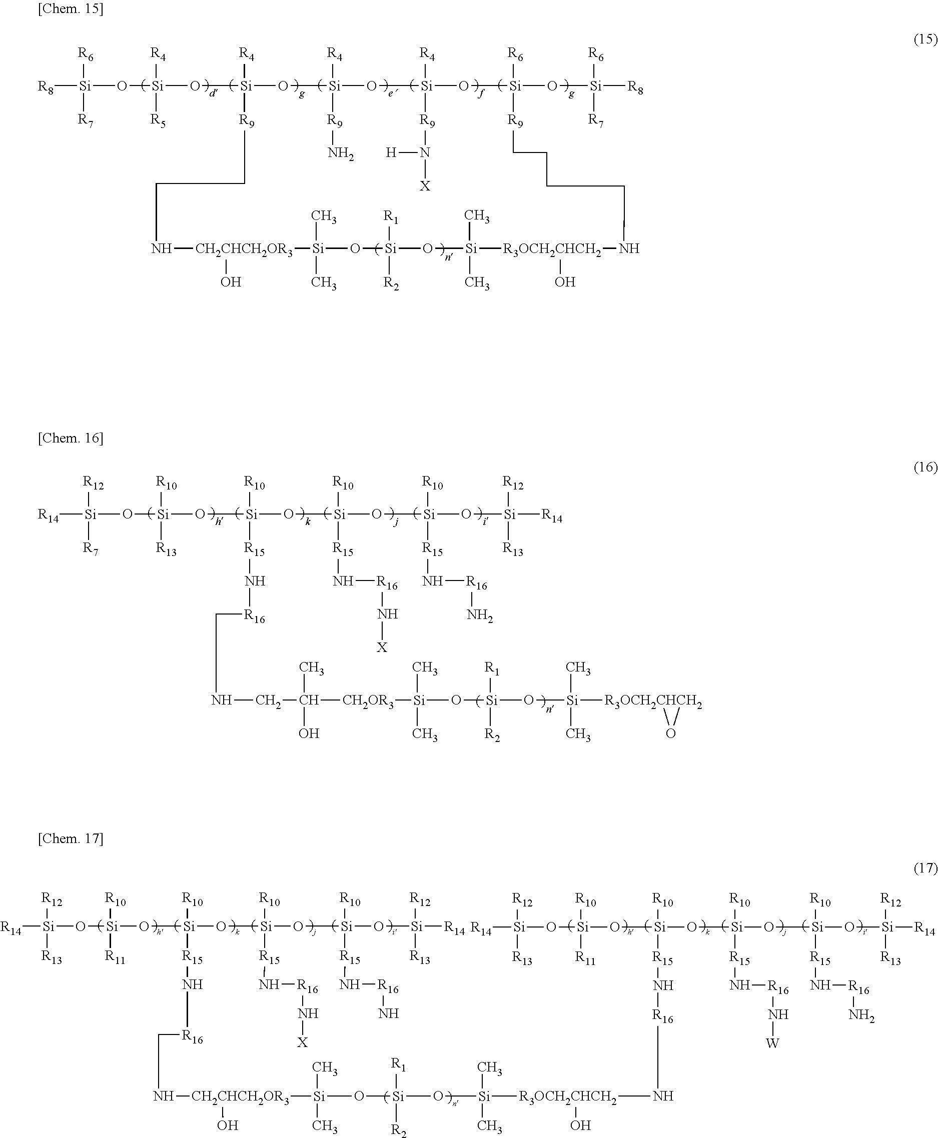

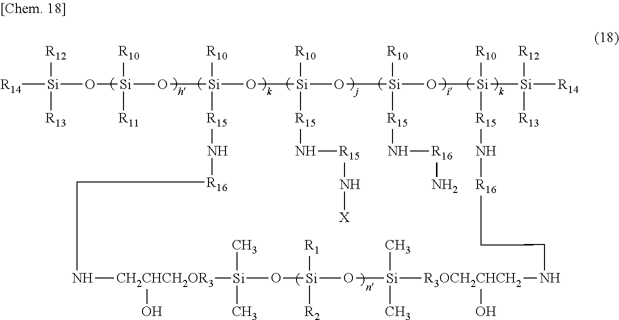

in the Formulas, R₁, R₂ and R₄˜R₁₆ represent independently an alkyl group, an alkenyl group, an aryl group, an aralkyl group, an alkylaryl group having 1˜18 carbon atoms, or —(CH₂)_{α}—NH—C₆H₅ (α represents an integer of 1˜8), wherein these groups may be entirely or partially substituted with halogen atoms. R₃, R₉, R₁₅ and R₁₆ represent independently a divalent organic group. d′, e′, h′, i′, n′ and b′ are an integer greater than or equal to 0, and f, g, j, k, a and c are an integer greater than 0. X and W represent independently a group represented by the following Formula (6).

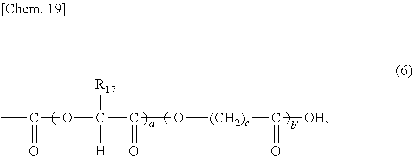

in the Formula (6), R₁₇ represents an alkyl group having 1˜18 carbon atoms. It is in particular preferred that the alkyl group is methyl group. b′ is an integer greater than or equal to 0, and a and c are an integer greater than 0.

In the polysiloxane-modified polylactic acid resins represented by these Formulas, the repetitive units each may be repeated by the repetitive number a, b′, d′, e′, f, g, h′, i′, j or k of the repetitive units, respectively, and the same repetitive unit may be continuously positioned or may be alternately positioned.

The polysiloxane-modified polylactic acid resin composition according to the present invention may be produced using the same method as in said polysiloxane-modified polylactic acid resin. Typically, a pre-prepared amino-containing polysiloxane compound and polylactic acid compound may be added, and they may be stirred and mixed in a melted state under shearing force to form said composition. The blending ratio of the amino-containing poly-siloxane compound and the polylactic acid compound may be determined such that an average content of amino group represented by the following Equation (22) is the range of 0.01˜2.5% by weight inclusive, and preferably 0.01˜1.0% by weight inclusive, and an amount of amino group with respect to the polylactic acid compound represented by the above Equation (23) is the range of 3˜300 ppm by weight inclusive.

Average content of an amino group in a polysiloxane compound (%)=(16/amino equivalent)×100 (24)

Also, the amino-containing polysiloxane, epoxy-containing polysiloxane, and poly-lactic acid compounds may be simultaneously added while stirring and mixing, but preferably the amino-containing polysiloxane compound and polylactic acid compound are first reacted, and subsequently the epoxy-containing polysiloxane compound is reacted. Preferably, the content of said epoxy-containing polysiloxane compound is within the range of 0˜10% by weight inclusive with respect to said polylactic acid compound polysiloxane-modified poly-lactic acid resin having the amino-containing polysiloxane compound segment.

The polysiloxane-modified polylactic acid resin composition thus obtained contains reacted products of the amino-containing polysiloxane compound with the epoxy-containing polysiloxane compound and unreacted epoxy-containing polysiloxane compounds, in addition to said polylactic acid compound polysiloxane-modified polylactic acid resin containing the polylactic acid compound segment and the amino-containing polysiloxane compound segment or the polylactic acid compound polysiloxane-modified polylactic acid resin containing further a segment comprised of a reacted product of amino-containing polysiloxane compound with the epoxy-containing polysiloxane compound. Said polylactic acid compound polysiloxane-modified polylactic acid resin having the amino-containing polysiloxane compound segment has high affinity to unreacted epoxy-containing polysiloxane compounds, or reacted products of amino-containing polysiloxane compound with epoxy-containing polysiloxane compound. As a result, the bleed of polysiloxane compounds from a molded product may be prevented, thereby improving the impact resistance and flexibility of the molded product.

Various additives such as nucleating agents, thermal stabilizing agents, antioxidants, coloring agents, fluorescent whitening agents, fillers, mold releasing agents, softeners, and antistatic agents; impact resistance enhancer; phosphorous flame retardants; thermal-absorbing agents such as metal hydroxides or borates; nitrogenous compounds such as melamines; and halogenous flame retardants may be added in the polysiloxane-modified polylactic acid resin composition, as long as the functions of said polysiloxane-modified polylactic acid resin is not inhibited.

If said polysiloxane-modified polylactic acid resin composition contains crystalline resins, to promote the crystallization of amorphous substances having low flow initiating temperature in forming a molded product, a nucleating agent may preferably be used. The nucleating agent itself acts as the nucleus of crystallization to arrange resin molecules to a regular 3-dimensional structure upon forming a molded product. By using the nucleating agent, the moldability, mechanical strength and thermal resistance of a molded product may be improved, and molding time may be shortened. Further, because the crystallization of amorphous substances is promoted, the deformation of a molded product is inhibited even when mold temperature is high, and the release of a mold after molding is facilitated. Even if the mold temperature is above the glass transition temperature Tg of the resin, the same effect may be obtained.

For the nucleating agent used, examples of inorganic nucleating agents may includes talc, calcium carbonate, mica, boron nitride, synthetic silicic acid, silicate, silica, caoline, carbon black, zinc flower, montmorillonite, clay minerals, basic magnesium carbonate, quartz powder, glass fiber, glass powder, diatomite, dolomite powder, titanium oxide, zinc oxide, antimony oxide, barium sulfate, alumina, calcium silicate, and boron nitride. Examples of organic nucleating agents may includes:

(1) organic carboxylic acids such as octylic acid, toluene acid, heptanic acid, pelargonic acid, lauric acid, myristic acid, palmitic acid, stearic acid, behenic acid, cerotic acid, montaic acid, melissic acid, benzoic acid, p-tert-butyl benzoic acid, terephthalic acids, monomethylester terephthalate, isophthalic acid, monomethylesters isophthalate, rosin acid, 12-hydroxystearic acid, or cholic acid;
(2) organic carboxylic alkaline metal salts such as alkaline metal salts of said organic carboxylic acids, or organic carboxylic alkaline-earth metal salts such as alkaline-earth metal salts of said organic carboxylic acids;
(3) polymeric organic compounds having metal salts of carboxyl group such as metal salts of carboxylic-containing polyethylene obtained from the oxidation of polyethylene, carboxylic-containing polypropylene obtained from the oxidation of polypropylene, copolymers of olefins such as ethylene, propylene or butene-1 and acrylic or methacrylic acid, copolymers of styrene and acrylic or methacrylic acid, copolymers of olefins and maleic anhydride, or copolymers of styrene and maleic anhydride;
(4) fatty carboxylic acid amides such as oleic acid amide, stearic acid amide, erucic acid amide, behenic acid amide, N-oleylpalmitoic acid amide, N-strearylerucic acid amide, N,N′-ethylenebis(strearamide), N,N′-methylenebis(strearamide), methylol.strearamide, ethylene-bisoleic acid amide, ethylenebisbehenic acid amide, ethylenebisstearic acid amide, ethylene-bislauric acid amides, hexamethylenebisoleic acid amide, hexamethylenebisstearic acid amide, butylenebisstearic acid amide, N,N′-dioleylsebacic acid amide, N,N′-dioleyladipic acid amide, N,N′-distearyladipic acid amide, N,N′-distearylsebacic acid amide, m-xylenebis-stearic acid amide, N,N′-distearylisophthalic acid amide, N,N′-distearylterephthalic acid amide, N-oleyloleic acid amide, N-stearyloleic acid amide, N-stearylerucic acid amide, N-oleylstearic acid amide, N-stearyl-stearic acid amide, N-butyl-N′-stearyl urea, N-propyl-N′-stearic acid urea, N-allyl-N′-stearyl urea, N-phenyl-N′-stearyl urea, N-stearyl-N-stearyl urea, dimethyl toll oil amide, dimethyllauric acid amide, dimethylstearic acid amide, N,N′-cyclohexanebis(stearamide), or N-lauroyl-L-glutamic acid-α,γ-n-butyl amide;
(5) polymeric organic compounds such as α-olefins branched at 3 position having 5 or more carbon atoms such as 3,3-dimethylbutene-1,3-methylbutene-1,3-methylpentene-1,3-methyl-hexene-1,3,5,5-trimethylhexene-1, or polymers of vinyl cycloalkane such as vinyl cyclo-pentane, vinyl cyclohexane, vinyl norbornane, or polyalkylene glycols such as polyethylene glycol, polypropylene glycol, polyglycol acids, cellulose, cellulose esters, cellulose esters, polyesters, or polycarbonates;
(6) phosphoric or hypophosphoric acid organic compounds or metal salts thereof such as diphenyl phosphate, diphenyl phosphite, sodium bis(4-tert-butylphenyl)phosphate, sodium methylene(2,4-tert-butylphenyl)phosphate;
(7) sorbitol derivatives such as bis(p-methylbenzylidene)sorbitol, or bis(p-ethylbenzylidene) sorbitol;
(8) cholesterol derivatives such as cholesteryl stearate, or cholesteryl oxystearamide;
(9) thioglicolic anhydride, paratoluenesulfonic acid, paratoluenesulfonic acid amide or metal salts thereof;
(10) phenyl sulfonic acid or metal salts thereof.

Among these, nucleating agents comprised of neutral substances that do not promote the hydrolysis of polyesters may preferably be used, since the hydrolysis of said polysiloxane-modified polylactic acid resin and hence the molecular weight decrease may be inhibited. Also, to inhibit the molecular weight decrease of said polysiloxane-modified polylactic acid resin due to interesterification, ester or amide compounds that are carboxyl group derivatives are better than nucleating agents having carboxyl groups, as ester or ether compounds that are hydroxyl group derivatives are better than nucleating agents having hydroxyl groups.

For organic nucleating agents, lamella compounds such as talc may preferably used since they are compatible with or micro-dispersible in a high temperature melted resin during a injection molding process, precipitated or phase separated within a mold during a cooling process, and act to the nucleus of crystallization. Such a nucleating agent may be used as any combination of inorganic and organic nucleating agents, or any combination of a number of these agents. Preferably, the content of the nucleating agent is 0.1˜20% by weight of the composition.

Examples of thermal stabilizing agents or antioxidants may include hindered phenols, phosphorous compounds, hindered amines, sulfur compounds, cupper compounds, alkaline metal halides, vitamin F, or the like. The content of these agents may be used within the range of 0.5 parts by weight or less with respect to 100 parts by weight of the polylactic acid resin.

Examples of fillers may include glass beads, glass flakes, talc powder, clay powder, mica, wollastonite powder, or silica powder.

As impact resistance enhancers, plasticizers may be used. Examples of plasticizers may include polymer block (copolymers) selected the group consisting of polyester segment, polyether segment and polyhydroxy carboxylic acid segment; block copolymers formed by the cross-linkage of polylactic acid segment, aromatic polyester segment and polyalkylene-ether segment; block copolymers formed by polylactic acid segment and polycaprolactone segment; polymers containing as a main component unsaturated carboxylic acid alkylester unit; aliphatic polyesters such as polybutylene succinate, polyethylene succinate, polycapro-lactone, polyethylene adipate, polypropylene adipate, polybutylene adipate, polyhexene adipate, or polybutylene succinate adipate; polyethyleneglycols or esters thereof; poly-glycerin acetate esters; epoxidized soybean oil; epoxidized flaxseed oil; epoxidized flaxseed oil fatty acid butyl; adipic acid aliphatic polyesters; tributyl acetylcitrate; acetylricinoleate esters; sucrose fatty acid esters; sorbitan fatty acid esters; dialkyl ester adipates; or alkyl-phthalylalkyl glycolates.

If necessary, other thermoplastic resins, for example, polypropylenes, polystyrenes, ABS, nylons, polyethylene therephthalates, polybutylene therephthalates or polycarbonates, or alloys thereof may be used. Crystalline thermoplastic resins such as polypropylenes, nylons, polyethylene therephthalates, polybutylene therephthalates, or alloys of these resins with polylactic acid resins may preferably used.

Also, thermosetting resins such as phenol, urea, melamine, alkid, acryl, unsaturated polyester, diallylphthalate, epoxy, silicone, cyanate, isocyanate, furan, ketone or xylene resins, thermosetting polyimides, thermosetting polyamides, styryl pyridine resins, nitrile terminated resins, addition-curable quinoxaline resins, and addition-curable polyquinoxaline resins, or thermosetting resins using plant-derived raw materials such as lignins, hemicelluloses or celluloses may be used. When such thermosetting resins are used, a curing agent or curing accelerator for a curing reaction may preferably be used.

Also, according to the present invention, a molded product may be produced using said polysiloxane-modified polylactic acid resin or said polysiloxane-modified polylactic acid resin composition. As a molding method, any of injection, injection/extrusion, extrusion, or mold molding methods may be used. Preferably, crystallization may be promoted during manufacturing process or after a molding process, thereby obtaining a molded product having good impact resistance and mechanical strength. As a method for promoting crystallization, for, example, nucleating agents listed above may be used within the range indicated above.

The molded product thus obtained has excellent impact resistance and mechanical strength, and the degeneration of product due to bleeding may be inhibited. Accordingly, the molded product is suitable for producing various parts used in electric devices, electronic devices, and automobiles.

### Examples

Hereinafter, the present invention will be described in more detail with reference to Examples, but the present invention is not limited to these Examples.

Details for each of materials used is as follows:

1. Polylactic acid resin (PLA): Terramac TE-4000N (melting point 170° C.) manufactured by Unitika Limited.
2. Amino-containing polysiloxane compound (C)
Regarding polysiloxane compounds used, the properties of each of side chain-diamino type polysiloxane compounds (C1), side chain-monoamino type polysiloxane compounds (C2), both ends-amino type polysiloxane compounds are shown in Tables 1˜3, respectively. Such polysiloxane compounds having amino groups may be prepared according to the matters described in Silicone Handbook (Daily Industrial Press, p165). Amino-containing poly-siloxane compounds having amino groups at its side chain may be synthesized using siloxane oligomer obtained by the hydrolysis of aminoalkyl methyldimethoxysilane, circular siloxane and a basic catalyst. Also, polysiloxane compounds having amino groups at its both ends may be obtained using bis(aminopropyl)tetramethyl disiloxane, circular siloxane and a basic catalyst. Alternatively, partially hydrolyzed condensate of diorganodichlorosilane may be dissolved in an organic solvent at a suitable amount depending on the molecular weight of siloxane compound and the ratio of M and D units of siloxane compound. Then, hydrolysis may be performed by adding water to form partially condensated siloxane compound. Then, triorganomonochlorosilane may be added to allow a reaction. At the end of polymerization, the solvent may be removed by distillation to give polysiloxane compound.

TABLE 1

| | | | | | Average |
|---|---|---|---|---|---|
| | | | | | content |
| | | | Viscosity | Amino | of amino |
| | | | [mm²/s] | Equivalent | group |
| Sample | Manufacturer | Model No. | (25° C.) | [g/mol] | [%] |
| C1-1 | SHIN-ETSU | X-22- | 15000 | 55000 | 0.03 |
| | CHEMICAL | 3820W | | | |
| | CO., LTD. | | | | |
| C1-2 | SHIN-ETSU | KF-8005 | 1200 | 11000 | 0.15 |
| | CHEMICAL | | | | |
| | CO., LTD. | | | | |
| C1-3 | SHIN-ETSU | KF-860 | 250 | 7600 | 0.21 |
| | CHEMICAL | | | | |
| | CO., LTD. | | | | |
| C1-4 | Dow Corning | FZ-3705 | 230 | 4000 | 0.40 |
| | Toray | | | | |
| | Silicone | | | | |
| C1-5 | SHIN-ETSU | KF-8002 | 1100 | 1700 | 0.94 |
| | CHEMICAL | | | | |
| | CO., LTD. | | | | |
| C1-6 | Dow Corning | BY16-849 | 1300 | 600 | 2.67 |
| | Toray | | | | |
| | Silicone | | | | |

TABLE 2

| | | | | | Average |
|---|---|---|---|---|---|
| | | | | | content |
| | | | Viscosity | Amino | of amino |
| | | | [mm²/s] | Equivalent | group |
| Sample | Manufacturer | Model No. | (25° C.) | [g/mol] | [%] |
| C2 | SHIN-ETSU | KF-865 | 110 | 5000 | 0.32 |
| | CHEMICAL | | | | |
| | CO., LTD. | | | | |

TABLE 3

| | | | | | Average |
|---|---|---|---|---|---|
| | | | | | content |
| | | | Viscosity | Amino | of amino |
| | | | [mm²/s] | Equivalent | group |
| Sample | Manufacturer | Model No. | (25° C.) | [g/mol] | [%] |
| C3-1 | Dow Corning | BY16- | 13 | 460 | 3.48 |
| | Toray | 853U | | | |
| | Silicone | | | | |
| C3-2 | SHIN-ETSU | KF-8012 | 90 | 2200 | 0.73 |
| | CHEMICAL | | | | |
| | CO., LTD. | | | | |
| C3-3 | SHIN-ETSU | X-22- | 550 | 2200 | 0.73 |
| | CHEMICAL | 1660B-3 | | | |
| | CO., LTD. | | | | |

3. Epoxy-containing polysiloxane compound (D)

Regarding epoxy-containing polysiloxane compounds used, the properties of each of both ends-epoxy type polysiloxane compounds (D1) and side chain-epoxy type polysiloxane compounds (D2) are shown in Tables 4 and 5, respectively. Such polysiloxane compounds having epoxy groups may be prepared according to the matters described in Silicone Hand-book (Daily Industrial Press, p164). An unsaturated epoxy compound like ally glycidyl ether and Dimethylpoly-siloxane having Si—H group may be addition-reacted under a platinum catalyst.

TABLE 4

| | | | Viscosity | | Average |
|---|---|---|---|---|---|
| | | | [mm²/s] | | content |
| | | | (convert to | Amino | of amino |
| | | Model | molecular | Equivalent | group |
| Sample | Manufacturer | No. | weight) | [g/mol] | [%] |
| D1 | SHIN-ETSU | KF105 | 15 | 490 | 8.8 |
| | CHEMICAL | | | | |
| | CO., LTD. | | | | |

TABLE 5

| | | | | | Average |
|---|---|---|---|---|---|
| | | | | | content |
| | | | Viscosity | Amino | of amino |
| | | Model | [mm²/s] | Equivalent | group |
| Sample | Manufacturer | No. | (25° C.) | [g/mol] | [%] |
| D2-1 | Dow Corning | SF8421 | 3000 | 11000 | 0.4 |
| | Toray | | | | |
| | Silicone | | | | |
| D2-2 | Dow Corning | SF8411 | 8000 | 3200 | 1.3 |
| | Toray | | | | |
| | Silicone | | | | |
| D2-3 | SHIN-ETSU | X-22- | 350 | 2500 | 1.7 |
| | CHEMICAL | 4741 | | | |
| | CO., LTD. | | | | |
| D2-4 | Dow Corning | FZ-3720 | 700 | 1200 | 3.6 |
| | Toray | | | | |
| | Silicone | | | | |
| D2-5 | SHIN-ETSU | X-22- | 190 | 620 | 6.9 |
| | CHEMICAL | 2000 | | | |
| | CO., LTD. | | | | |
| D2-6 | SHIN-ETSU | KF101 | 1500 | 350 | 12.3 |
| | CHEMICAL | | | | |
| | CO., LTD. | | | | |
| D2-7 | SHIN-ETSU | X-22- | 2500 | 250 | 17.2 |
| | CHEMICAL | 3000T | | | |
| | CO., LTD. | | | | |

4. Organic nucleating agent (E): ITOHWAX J-530 (N.N′-ethylenebis-12-hydroxy stearyl-amide) manufactured by Itoh Corporation.
5. Polysiloxane compound (F): KF96 (Viscosity: 200 [mm²/s] (25° C.)) manufactured by SHIN-ETSU CHEMICAL CO., LTD.
6. Polycarbonate resin (PC): CALIBRE 301˜22 (Weight average molecular weight 47000, Number average molecular weight 27000) manufactured by Sumitomo Dow Limited.

### Working Examples 1˜17, Comparative Examples 1,11˜19

### Production of Thermal Conductive Resin Composition by Hand Mixing and Injection Molded Product

PLA and siloxane compounds shown in Table 1˜5 were mixed by hand mixing for about 5 min at 190˜200° C. according to the ratios shown in Tables 6˜10. To prevent polysiloxane compounds having amino groups from being reacted directly with polysiloxane compounds having epoxy groups during hand mixing, PLA and polysiloxane compounds having amino groups were sufficiently melted and mixed, and then polysiloxane compounds having epoxy groups were added. The resulting mixtures were compressed at 175° C., and a plate-like samples having 70×70×2 mm dimension were prepared. The resulting samples were subjected to bending property as indicated below.

### [Evaluation of Bending]

The samples were subjected to a bending strength test using a multifunctional tester (Instron Model 5567) based on JIS Standard K7203. The test was performed after treating the samples at 110° C. for 2 hours, and completing crystallization. The results are shown in Tables 6˜12.

### [Evaluation of Bleed Resistance]

After each of molded bodies obtained by compression molding were retained in a thermo-hygrostat maintained at 60° C., 95% RH for 60 hours, the surface of samples were observed using microscope to evaluate a surface bleed according to the criteria indicated below. The results are shown in Tables 6˜12.

∘: no surface bleed
Δ: slight surface bleed
x: high surface bleed

TABLE 6

| | | Comparative | Working | Working | Working | Comparative | Working |
|---|---|---|---|---|---|---|---|
| Items | | example 1 | example 1 | example 2 | example 3 | example 11 | example 4 |
| PLA | % by | 100 | 97.0 | 97.0 | 97.0 | 97.0 | 97.0 |
| C1-3 | weight | | 3.0 | | | | |
| C1-4 | | | | 3.0 | | | |
| C1-5 | | | | | 3.0 | | |
| C1-6 | | | | | | 3.0 | |
| C2 | | | | | | | 3.0 |
| Ratio of | ppm | — | 63 | 120 | 282 | 800 | 96 |
| amino | | | | | | | |
| group to | | | | | | | |
| PLA | | | | | | | |
| Bending | MPa | 119 | 89.0 | 88.3 | 83.6 | 87.6 | 92.0 |
| strength | | | | | | | |
| Bending | GPa | 2.99 | 3.74 | 3.93 | 3.51 | 3.57 | 4.36 |
| modulus | | | | | | | |
| Rupture | % | 4.2 | 6.3 | 6.6 | 4.4 | 3.3 | 6.9 |
| bending | | | | | | | |
| strain | | | | | | | |
| Bleed | | — | ◯ | ◯ | ◯ | ◯ | ◯ |
| resistance | | | | | | | |

TABLE 7

| | | Comparative | Working | Working | Working | Working | Working | Working |
|---|---|---|---|---|---|---|---|---|
| Items | | example 1 | example 5 | example 6 | example 7 | example 8 | example 9 | example 10 |
| PLA | % by | 100 | 97.0 | 97.0 | 97.0 | 97.0 | 97.0 | 97.0 |
| C1-1 | weight | | 1.5 | | | | | |
| C1-2 | | | | 1.5 | | | | |
| C1-3 | | | | | 1.5 | | | |
| C1-4 | | | | | | 1.5 | | |
| C1-5 | | | | | | | 1.5 | |
| C2 | | | | | | | | 1.5 |
| D1 | | | 1.5 | 1.5 | 1.5 | 1.5 | 1.5 | 1.5 |
| Ratio of | ppm | | 4.5 | 22 | 31.5 | 60 | 141 | 48 |
| amino | | | | | | | | |
| group to | | | | | | | | |
| PLA | | | | | | | | |
| Bending | MPa | 119 | 82.9 | 82.7 | 86.1 | 73.9 | 8 0.7 | 77.0 |
| strength | | | | | | | | |
| Bending | GPa | 2.99 | 4.18 | 4.27 | 4.26 | 3.41 | 3.4 8 | 3.75 |
| modulus | | | | | | | | |
| Rupture | % | 4.2 | 19.3 | 9.2 | 10.1 | >20 | 12.4 | >20 |
| bending | | | | | | | | |
| strain | | | | | | | | |
| Bleed | | — | ◯ | ◯ | ◯ | ◯ | ◯ | ◯ |
| resistance | | | | | | | | |

TABLE 8

| | | Comparative | Comparative |
|---|---|---|---|
| Items | | example 1 | example 12 |
| PLA | % by | 100 | 97.0 |
| C1-6 | weight | | 1.5 |
| D1 | | | 1.5 |
| Ratio of amino group to | ppm | | 400 |
| PLA | | | |
| Bending strength | MPa | 119 | 82.8 |
| Bending modulus | GPa | 2.99 | 3.93 |
| Rupture bending strain | % | 4.2 | 4.5 |
| Bleed resistance | | — | ◯ |

TABLE 9

| | | Comparative | Comparative | Comparative | Comparative | Comparative |
|---|---|---|---|---|---|---|
| Items | | example 1 | example 13 | example 14 | example 15 | example 16 |
| PLA | % by | 100 | 97.0 | 97.0 | 97.0 | 97.0 |
| C3-1 | weight | | 3.0 | | | |
| C3-2 | | | | 3.0 | | |
| C3-3 | | | | | 3.0 | |
| D1 | | | | | | 3.0 |
| Ratio of | ppm | — | 1043 | 218 | 218 | — |
| amino | | | | | | |
| group to | | | | | | |
| PLA | | | | | | |
| Bending | MPa | 119 | 76.8 | 86.2 | 94.5 | 75.3 |
| strength | | | | | | |
| Bending | GPa | 2.99 | 3.79 | 4.03 | 3.67 | 3.39 |
| modulus | | | | | | |
| Rupture | % | 4.2 | 2.6 | 3.3 | 3.4 | 7.3 |
| bending | | | | | | |
| strain | | | | | | |
| Bleed | | — | Δ | X | X | Δ |
| resistance | | | | | | |

TABLE 10

| | | Comparative | Comparative | Comparative | Comparative |
|---|---|---|---|---|---|
| Items | | example 1 | example 17 | example 18 | example 19 |
| PLA | % by weight | 100 | 97.0 | 97.0 | 97.0 |
| C3-1 | | | 1.5 | | |
| C3-2 | | | | 1.5 | |
| C3-3 | | | | | 1.5 |
| D1 | | | 1.5 | 1.5 | 1.5 |
| Ratio of amino | ppm | — | 522 | 109 | 109 |
| group to PLA | | | | | |
| Bending | MPa | 119 | 74.5 | 75.4 | 84.0 |
| strength | | | | | |
| Bending | GPa | 2.99 | 4.12 | 3.87 | 3.83 |
| modulus | | | | | |
| Rupture | % | 4.2 | 3.7 | 7.4 | 6.0 |
| bending strain | | | | | |
| Bleed | | — | Δ | Δ | Δ |
| resistance | | | | | |

TABLE 11

| | | Comparative | Working | Working | Working |
|---|---|---|---|---|---|
| Items | | example 1 | example 11 | example 12 | example 13 |
| PLA | % by weight | 100 | 97.0 | 97.0 | 97.0 |
| C1-4 | | | 1.5 | 1.5 | 1.5 |
| D2-1 | | | 1.5 | | |
| D2-2 | | | | 1.5 | |
| D2-3 | | | | | 1.5 |
| Ratio of amino | ppm | | 60 | 60 | 60 |
| group to PLA | | | | | |
| Bending | MPa | 119 | 78.9 | 86.7 | 86.5 |
| strength | | | | | |
| Bending | GPa | 2.99 | 3.52 | 3.41 | 3.57 |
| modulus | | | | | |
| Rupture | % | 4.2 | 11.1 | 10.5 | 9.7 |
| bending strain | | | | | |
| Bleed | | — | ◯ | ◯ | ◯ |
| resistance | | | | | |

TABLE 12

| | | Comparative | Working | Working | Working | Working example |
|---|---|---|---|---|---|---|
| Items | | example 1 | example 14 | example 15 | example 16 | 17 |
| PLA | % by | 100 | 97.0 | 97.0 | 97.0 | 98.5 |
| C1-4 | weight | | 1.5 | 1.5 | 1.5 | 1.5 |
| D2-4 | | | 1.5 | | | |
| D2-5 | | | | 1.5 | | |
| D2-6 | | | | | 1.5 | |
| D2-7 | | | | | | 1.5 |
| Ratio of amino | ppm | | 60 | 60 | 60 | 60 |
| group to PLA | | | | | | |
| Bending strength | MPa | 119 | 86.7 | 81.1 | 82.9 | 92.5 |
| Bending | GPa | 2.99 | 3.83 | 3.75 | 3.68 | 3.73 |
| modulus | | | | | | |
| Rupture bending | % | 4.2 | 6.4 | 5.1 | 6.0 | 6.6 |
| strain | | | | | | |
| Bleed resistance | | — | ◯ | ◯ | ◯ | ◯ |

As can be seen from the results of Working Examples 1˜4, the polysiloxane-modified polylactic acid resin compositions in which the average contents of amino groups of amino-containing polysiloxane compounds having amino groups at its side chains were 0.01˜2.5%, and the ratios of amino group to PLA were 3˜300 ppm had good rupture bending strain and did not exhibit any surface bleed. To the contrary, Comparative Example 11 in which the average content of amino groups of amino-containing polysiloxane compound having amino groups at its side chain was more than 2.5%, and the ratio of amino group to PLA was more than 300 ppm, exhibited rupture bending strain lower than PLA (Comparative Example 1).

Further, the polysiloxane-modified polylactic acid resin compositions obtained using polysiloxane compounds having amino groups at its both ends (Comparative Examples 13˜15) exhibited rupture bending strain lower than PLA and surface bleed was generated.

Also, as can be seen from the results of Working Examples 5˜10, the polysiloxane-modified polylactic acid resin compositions in which the average contents of amino groups of amino-containing polysiloxane compounds were 0.01˜2.5%, the ratios of amino group to PLA were 3˜300 ppm, and polysiloxane compounds having epoxy groups were blended had significant improved rupture bending strain and did not exhibit any surface bleed. To the contrary, in case of Comparative Example 12 in which the average content of amino groups of amino-containing polysiloxane compound was more than 2.5%, and the ratio of amino group to PLA was more than 300 ppm, even if epoxy-modified polysiloxane compound was blended, rupture bending strain was not improved.

Also, as can be seen from the results of Working Examples 11˜13, the polysiloxane-modified polylactic acid resin compositions in which epoxy-containing polysiloxanes having the average epoxy group contents of less than 2% and polysiloxane compounds having amino groups at its side chains which satisfy the aforementioned average amino group content were used, and the ratios of amino group to PLA were 3˜300 ppm had improved rupture bending strain, compared to PLA of Comparative Example 1, or the polylactic acid resin composition of Comparative Example 16 in which epoxy-containing polysiloxane compound was blended into PLA. To the contrary, when using polysiloxane compounds having amino groups at its both ends and epoxy-containing polysiloxane compounds (Comparative Example 17˜19), rupture bending strain was not improved, compared to the polylactic acid resin composition of Comparative Example 16 in which epoxy-containing polysiloxane compound was blended into PLA.

Also, as can be seen from the results of Working Examples 14˜17, the polysiloxane-modified polylactic acid resin compositions in which epoxy-containing polysiloxanes having the average epoxy group contents of 2% or more and polysiloxane compounds having amino groups at its side chains which satisfy the aforementioned average amino group content were used with PLA, and the ratios of amino group to PLA were 3˜300 ppm had improved rupture bending strain than PLA of Comparative Example 1, but the extent of the improved rupture bending strain was lower than in polysiloxane-modified polylactic acid resin compositions of Working Examples 11˜13 in which epoxy-containing polysiloxanes having the average epoxy group contents of less than 2% and polysiloxane compounds having amino groups at its side chains which satisfy the aforementioned average amino group content were used with PLA, and the ratios of amino group to PLA were 3˜300 ppm.

### Working Examples 18˜21, Comparative Examples 2, 20, 21

Mixtures in which PLA and if necessary, organic crystal nucleating agents (E) were blended according to the ratios shown in Tables 13˜15 were supplied from a hoper mouth of a continuous mixing extruder (Berstorff Model ZE 40A×40D, L/D=40, screw diameter φ40) with its cylinder temperature set to 190° C. Also, polysiloxane compounds having amino groups at its side chains and polysiloxanes having epoxy groups at its both ends (D) were separately supplied from vent apertures according to the ratios shown in Tables 13˜15. The sum of amounts supplied per 1 hour was adjusted to 15˜20 kg/h. After the mixtures were stirred and mixed in a melted state under shearing force by rotating a screw at 150 rpm, the mixtures were extruded into a strand shape from die apertures of the extruder. The extruded strands were cooled in water, and cut into pellets. Thus, pellets of polysiloxane-modified polylactic acid resin compositions were obtained.

After drying the resulting pellets at 100° C. for 5 hours, they were molded using an injection-molding machine (Toshiba Model EC20P-0.4A, Molding temperature 190° C., Mold temperature 25° C.) to obtain specimens (125×13×3.2 mm). The specimens were evaluated for bending property and bleed resistance as in Working Example 1. Also, IZOD impact strength and bending strain were tested using methods indicated below. The results are shown in Tables 13˜15 and FIGS. 1˜3.

### [Evaluation of IZOD Impact Strength and Bending Strain]

The obtained specimens were retained in a thermo-hygrostat at 110° C. for 2 hours, and subjected to crystallization. Then, the specimens were cooled to room temperature, and tested for IZOD impact strength and bending property. To determine IZOD impact strength, after notching the specimens impact strength of the molded product were measured based on JIS K7110. The bending property was evaluated using a multifunctional tester (Instron Model 5567) based on ASTM D790.

### [Evaluation of Bleed Resistance]

After each of molded bodies obtained by compression molding were retained in a thermo-hygrostat maintained at 60° C., 95% RH for 60 hours, the surface of samples were observed using microscope to evaluate a surface bleed according to the criteria indicated below. The results are shown in Tables 6˜12.

∘: no surface bleed
Δ: slight surface bleed
x: high surface bleed

### [Evaluation of Polysiloxane Compound Dispersibility]

The specimens were cut into small pieces. The pieces were melted on 200° C. hot plate, and histological staining specimens were prepared. The dispersibility of polysiloxane compounds were observed with images (FIGS. 4˜7) magnified 300 times using optical microscope (KEYENCE Model VHX-500).

TABLE 13

| | | Comparative | Working | Working |
|---|---|---|---|---|
| Items | | example 2 | example 18 | example 19 |
| PLA | % by | 100 | 98.5 | 97 |
| C1-4 | weight | — | 1.5 | 3 |
| Ratio of amino | ppm | | 60 | 120 |
| group to PLA | | | | |
| IZOD impact | kJ/m² | 3.5 | 14.9 | 16.3 |
| test | | | | |
| Bending | MPa | 110 | 103 | 87.7 |
| strength | | | | |
| Bending | GPa | 4.2 | 4.4 | 3.7 |
| modulus | | | | |
| Rupture | % | 3.3 | 11.1 | >20 |
| bending strain | | | | |
| Maximum | MPa | 63 | 46 | 42 |
| tensile stress | | | | |
| Young's | MPa | 2.5 | 3.1 | 2.9 |
| Modulus | | | | |
| Tensile strain at | % | 4.3 | 18.8 | 21.7 |
| break | | | | |
| Bleed | | — | ◯ | ◯ |
| resistance | | | | |

TABLE 14

| | | Comparative | Working | Working |
|---|---|---|---|---|
| Items | | example 2 | example 20 | example 21 |
| PLA | % by | 100 | 97 | 96 |
| C1-4 | weight | — | 1.5 | 2 |
| D1 | | — | 1.5 | 2 |
| Organic crystal | | — | — | — |
| nucleating | | | | |
| agent (E) | | | | |
| Ratio of amino | ppm | | 60 | 90 |
| group to PLA | | | | |
| IZOD impact | kJ/m² | 3.46 | 18.6 | 18.1 |
| test | | | | |
| Bending | MPa | 110 | 84.0 | 75.5 |
| strength | | | | |
| Bending | GPa | 4.20 | 4.30 | 3.80 |
| modulus | | | | |
| Rupture | % | 3.3 | >20 | >20 |
| bending strain | | | | |
| Maximum | MPa | 63 | 35 | 32 |
| tensile stress | | | | |
| Young's | MPa | 2.5 | 2.9 | 2.8 |
| Modulus | | | | |
| Tensile strain at | % | 4.3 | 28.8 | 41.0 |
| break | | | | |
| Bleed | | — | ◯ | ◯ |
| resistance | | | | |

Thus, as can be seen from the results of Working Examples 18˜21, the polysiloxane-modified polylactic acid resin compositions using amino-containing polysiloxane compounds (Working Example 18, 19), and the polysiloxane-modified polylactic acid resin compositions having epoxy-containing polysiloxane compounds blended (Working Example 20, 21) had excellent impact strength, rupture bending strain and tensile breaking strain, as well as not exhibiting any surface bleed.

Also, Working Example 20 where epoxy-containing polysiloxane compound was used with amino-containing polysiloxane compound had better tensile breaking strain and impact strength than in Working Example 19 where amino-containing polysiloxane compound alone was used. It is believed that the reason is that some of amino-containing polysiloxane compound was reacted with some of epoxy-containing polysiloxane compound to form cross-linkages and improve elastromeric property, or plasticity was improved by virtue of unreacted epoxy-containing polysiloxane compound. To the contrary, in case of the polylactic acid resin composition in which the average content of amino group of polysiloxane compound having amino groups was more than 2.5%, and the ratio of amino group to PLA was more than 300 ppm (Comparative Example 20), any surface bleed was not generated, but tensile breaking strain was not improved.

In cases of Working Examples 19 and 20, polysiloxane compounds were dispersed with the particle size of about 10 μm or less (FIGS. 4 and 5). To the contrary, in case of the polylactic acid resin composition in which the average content of amino group of polysiloxane compound having amino groups was more than 2.5%, and the ratio of amino group to PLA was more than 300 ppm (Comparative Example 20, FIG. 6), polysiloxane compounds were micronized as much as unobservable. Further, this composition did not exhibit any improvement in rupture bending strain or tensile breaking strain. It is believed that the reason is that since the amount of amino groups in amino-containing polysiloxane compound was too high, they were effectively reacted with PLA and mingled in molecular orders, and since the interaction of PLA and the polysiloxane-modified polylactic acid resin is too strong, the sliding of molecules was not generated.

Further, in case of the polysiloxane-modified polylactic acid resin composition using polysiloxane compound having no amino group (Comparative Example 21), it is difficult to mix polysiloxane compound and polylactic acid compound. Also, since mixed pellets are slippery, it is very difficult to perform injection molding. It would be arisen that the molded specimen exhibited surface bleed since the particles of the dispersed polysiloxane compound has a large particle size, and the interface adhesion is weak.

As described above, to achieve excellent impact strength, rupture bending strain and tensile breaking strain, and inhibit surface bleed, it is demonstrated that the polysiloxane-modified polylactic acid resin composition should be designed such that polysiloxane compounds having high elastromeric property can be dispersed with a proper particle size, and also the good interface adhesion can be achieved by the reaction with a polylactic acid resin.

The present application includes all of matters included in JP Patent Application No. 2009˜53175 (filed on Mar. 6, 2009).

The polysiloxane-modified polylactic acid resin according to the present invention has impact resistance equivalent to ABS resins, thereby allowing the use as the alternative to ABS resins. Also, the polysiloxane-modified polylactic acid resin according to the present invention may be produced by a simply process, and does not exhibit surface bleed. Thus, the polysiloxane-modified polylactic acid resin according to the present invention is a very useful material, which can be used as, for example exterior finishing materials for electric or electronic devices requesting high impact resistance.

What is claimed is:

1. A polysiloxane-modified polylactic acid resin having a segment of a polylactic acid compound, and a segment of an amino-containing polysiloxane compound having an amino group, wherein the amino group is on average contained in the range of 0.01 to 2.5% inclusive by weight with respect to the amino-containing polysiloxane compound, and is on average contained in the range of 3 to 300 ppm inclusive by weight with respect to the polylactic acid compound, and the amino-containing polysiloxane compound has the amino group at its side chain and has a number average molecular weight of 900-30000 inclusive,
wherein the segment of the amino-containing polysiloxane compound includes segments comprised of reacted products of said amino-containing polysiloxane compounds with epoxy-containing polysiloxane compounds having an epoxy group, and
wherein the epoxy-containing polysiloxane compound includes at least one of epoxy-containing poly-siloxane compounds represented by the Formula (12), (19), (20) or (21), and the epoxy-containing polysiloxane compounds represented by the Formulas (19) or (21) contains epoxy groups of an average of less than 2% by weight: 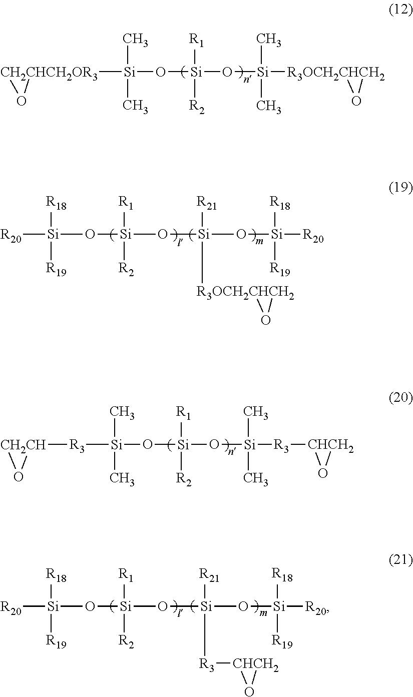
wherein in Formula (12), (19), (20) or (21), R₁, R₂ and R₁₈-R₂₁ represent independently an alkyl group, an alkenyl group, an aryl group, an aralkyl group, an alkylaryl group having 1-18 carbon atoms, or —(CH₂)_{α}—NH—C₆H₅ (α represents an integer of 1-8), wherein they may be entirely or partially substituted with halogen atoms; R₃ represents a divalent organic group; l′ and n′ are an integer greater than or equal to 0; and m is an integer greater than 0.

2. The polysiloxane-modified polylactic acid resin according to claim 1, wherein the amino-containing polysiloxane compound includes at least one of amino-containing poly-siloxane compounds represented by the Formulas (1) or (2): 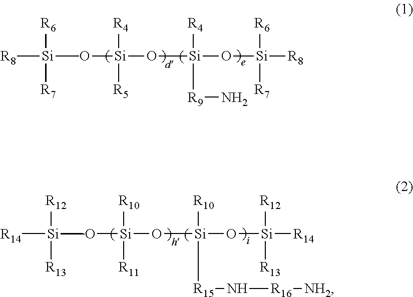
wherein in Formulas (1) and (2), R₄-R₈ and R₁₀-R₁₄ represent independently an alkyl group, an alkenyl group, an aryl group, an aralkyl group, an alkylaryl group having 1-18 carbon atoms, or —(CH₂)_{α}—NH—C₆H₅ (α represents an integer of 1˜8), wherein they may be entirely or partially substituted with halogen atoms; R₉, R₁₅ and R₁₆ represent independently a divalent organic group; d′ and h′ are an integer greater than or equal to 0; and e and i are an integer greater than 0; and
wherein the polysiloxane-modified polylactic acid compound is represented by any one of Formulas (3)-(5), (8), (11), (13)-(17) or (18): 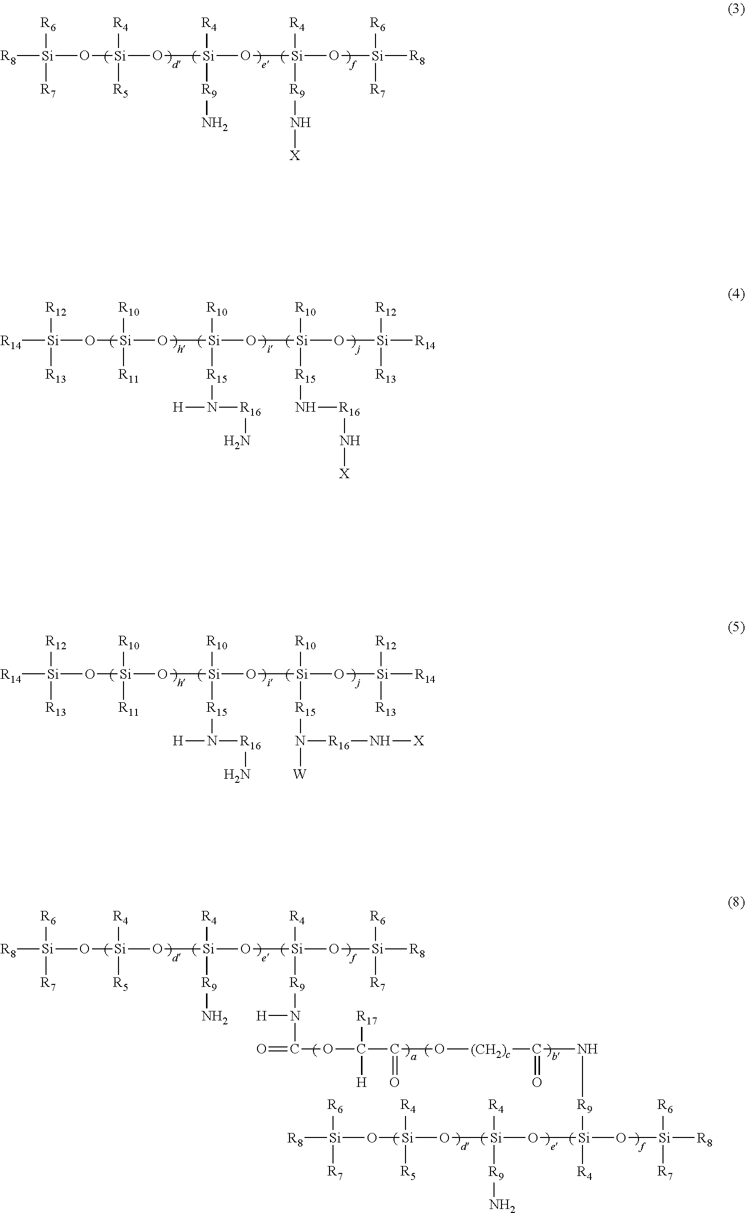 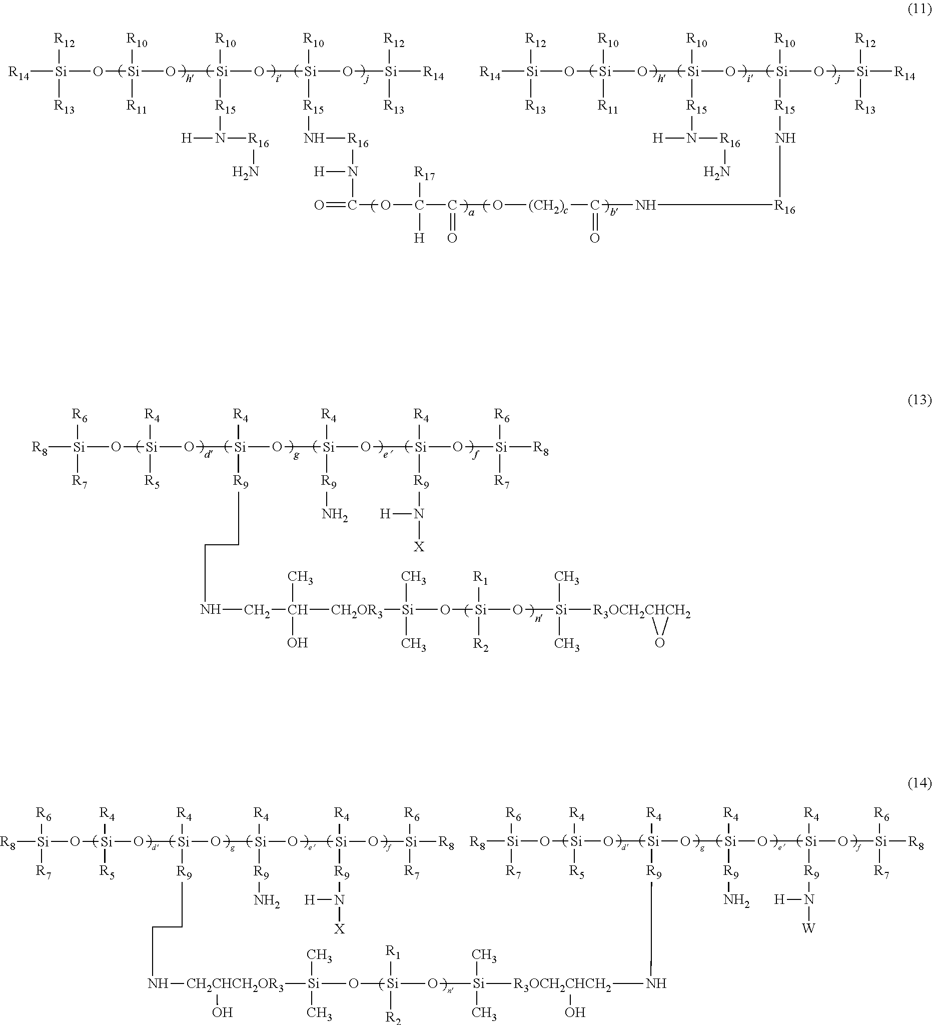 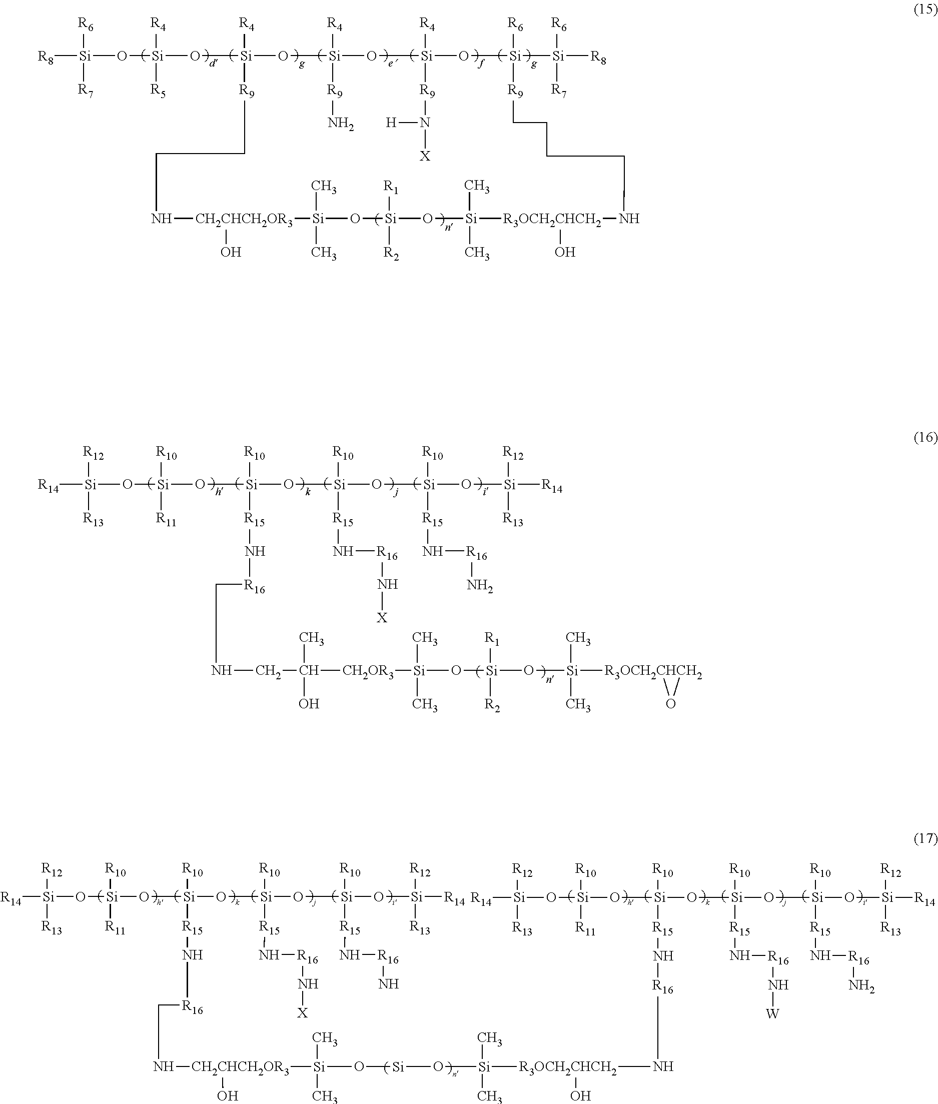 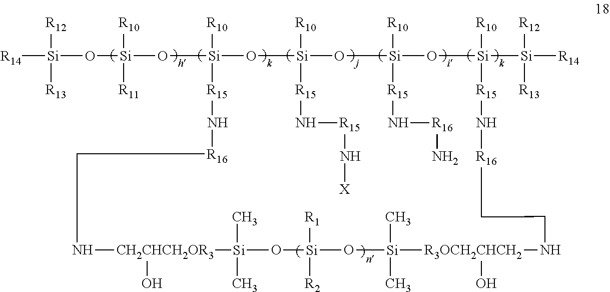
wherein in Formulas (3)-(5), (8), (11), (13)-(17) and (18), R₁, R₂ and R₄˜R₁₄ represent independently an alkyl group, an alkenyl group, an aryl group, an aralkyl group, an alkylaryl group having 1˜18 carbon atoms, or —(CH₂)_{α}—NH—C₆H₅ (α represents an integer of 1˜8), wherein they may be entirely or partially substituted with halogen atoms; R₃, R₉, R₁₅ and R₁₆ represent independently a divalent organic group; d′, e′, h′, i′, n′ and b′ are an integer greater than or equal to 0; f, g, j, k, a and c are an integer greater than 0; X and W represent independently a group represented by the following Formula (6): 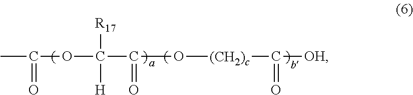
wherein in Formula (6), R₁₇ represents an alkyl group having 1˜18 carbon atoms; b′ is an integer greater than or equal to 0; and a and c are an integer greater than 0.

3. A polysiloxane-modified polylactic acid resin composition, wherein the composition is obtained by mixing and stirring at least one selected from amino-containing polysiloxane compounds, at least one selected from epoxy-containing polysiloxane compounds, and a melted polylactic acid compound, and the amino group is on average contained in the range of 0.01 to 2.5% inclusive by weight with respect to the amino-containing polysiloxane compound, and is on average contained in the range of 3 to 300 ppm inclusive by weight with respect to the polylactic acid compound, and the amino-containing polysiloxane compound has the amino group at its side chain and has a number average molecular weight of 900-30000 inclusive wherein the segment of the amino-containing polysiloxane compound includes segments comprised of reacted products of said amino-containing polysiloxane compounds with epoxy-containing polysiloxane compounds having an epoxy group, and
wherein the epoxy-containing polysiloxane compound includes at least one of epoxy-containing poly-siloxane compounds represented by the Formula (12), (19), (20) or (21), and the epoxy-containing polysiloxane compounds represented by the Formulas (19) or (21) contains epoxy groups of an average of less than 2% by weight: 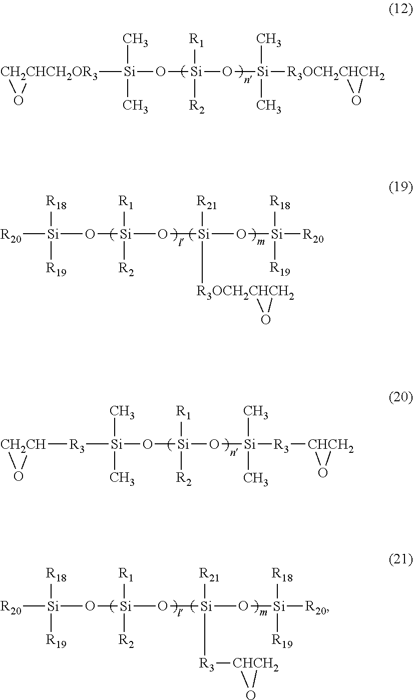
wherein in Formula (12), (19), (20) or (21), R₁, R₂ and R₁₈-R₂₁ represent independently an alkyl group, an alkenyl group, an aryl group, an aralkyl group, an alkylaryl group having 1-18 carbon atoms, or —(CH₂)_{α}—NH—C₆H₅ (α represents an integer of 1-8), wherein they may be entirely or partially substituted with halogen atoms; R₃ represents a divalent organic group; l′ and n′ are an integer greater than or equal to 0; and m is an integer greater than 0.

4. A polysiloxane-modified polylactic acid resin composition, wherein the composition is obtained by mixing and stirring at least one selected from amino-containing polysiloxane compounds and a melted polylactic acid compound, and subsequently adding at least one selected from epoxy-containing polysiloxane compounds, and mixing and stirring, and the amino group is on average contained in the range of 0.01 to 2.5% inclusive by weight with respect to the amino-containing polysiloxane compound, and is on average contained in the range of 3 to 300 ppm inclusive by weight with respect to the polylactic acid compound, and the amino-containing polysiloxane compound has the amino group at its side chain and has a number average molecular weight of 900-30000 inclusive wherein the segment of the amino-containing polysiloxane compound includes segments comprised of reacted products of said amino-containing polysiloxane compounds with epoxy-containing polysiloxane compounds having an epoxy group, and
wherein the epoxy-containing polysiloxane compound includes at least one of epoxy-containing poly-siloxane compounds represented by the Formula (12), (19), (20) or (21), and the epoxy-containing polysiloxane compounds represented by the Formulas (19) or (21) contains epoxy groups of an average of less than 2% by weight: 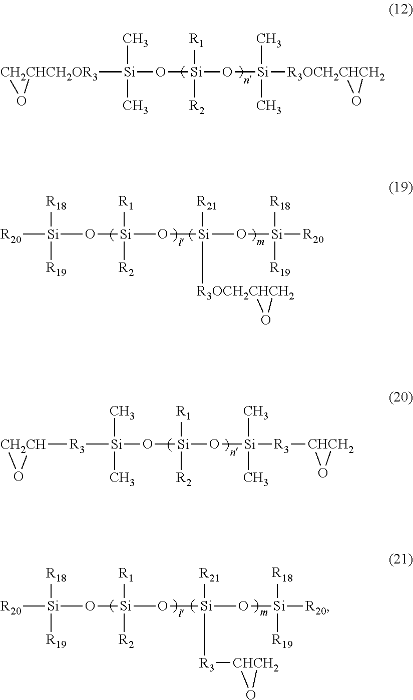
wherein in Formula (12), (19), (20) or (21), R₁, R₂ and R₁₈-R₂₁ represent independently an alkyl group, an alkenyl group, an aryl group, an aralkyl group, an alkylaryl group having 1-18 carbon atoms, or —(CH₂)_{α}—NH—C₆H₅ (α represents an integer of 1-8), wherein they may be entirely or partially substituted with halogen atoms; R₃ represents a divalent organic group; l′ and n′ are an integer greater than or equal to 0; and m is an integer greater than 0.

5. A molded product obtained by using at least one selected from the polysiloxane-modified polylactic acid resin according to claim 1.

6. A method for the production of a polysiloxane-modified polylactic acid resin composition comprising mixing and stirring at least one selected from amino-containing polysiloxane compounds, at least one selected from epoxy-containing polysiloxane compounds, and a melted polylactic acid compound, and wherein the amino group is on average contained in the range of 0.01 to 2.5% inclusive by weight with respect to the amino-containing polysiloxane compound, and is on average contained in the range of 3 to 300 ppm inclusive by weight with respect to the polylactic acid compound, and the amino-containing polysiloxane compound has the amino group at its side chain and has a number average molecular weight of 900-30000 inclusive wherein the segment of the amino-containing polysiloxane compound includes segments comprised of reacted products of said amino-containing polysiloxane compounds with epoxy-containing polysiloxane compounds having an epoxy group, and
wherein the epoxy-containing polysiloxane compound includes at least one of epoxy-containing poly-siloxane compounds represented by the Formula (12), (19), (20) or (21), and the epoxy-containing polysiloxane compounds represented by the Formulas (19) or (21) contains epoxy groups of an average of less than 2% by weight: 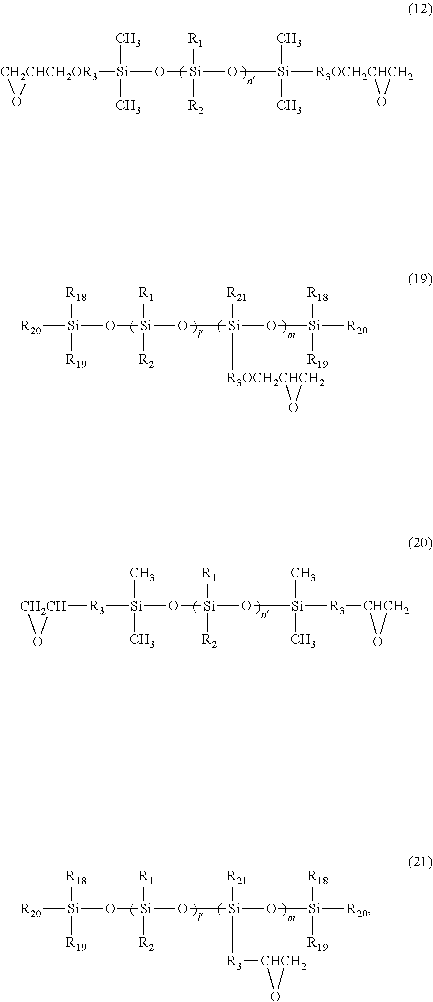
wherein in Formula (12), (19), (20) or (21), R₁, R₂ and R₁₈-R₂₁ represent independently an alkyl group, an alkenyl group, an aryl group, an aralkyl group, an alkylaryl group having 1-18 carbon atoms, or —(CH₂)_{α}—NH—C₆H₅ (α represents an integer of 1-8), wherein they may be entirely or partially substituted with halogen atoms; R₃ represents a divalent organic group; l′ and n′ are an integer greater than or equal to 0; and m is an integer greater than 0.

7. A method for the production of a polysiloxane-modified polylactic acid resin composition comprising mixing and stirring at least one selected from amino-containing polysiloxane compounds and a melted polylactic acid compound, and subsequently adding at least one selected from epoxy-containing polysiloxane compounds, and mixing and stirring, and wherein the amino group is on average contained in the range of 0.01 to 2.5% inclusive by weight with respect to the amino-containing polysiloxane compound, and is on average contained in the range of 3 to 300 ppm inclusive by weight with respect to the polylactic acid compound, and the amino-containing polysiloxane compound has the amino group at its side chain and has a number average molecular weight of 900-30000 inclusive wherein the segment of the amino-containing polysiloxane compound includes segments comprised of reacted products of said amino-containing polysiloxane compounds with epoxy-containing polysiloxane compounds having an epoxy group, and wherein the epoxy-containing polysiloxane compound includes at least one of epoxy-containing poly-siloxane compounds represented by the Formula (12), (19), (20) or (21), and the epoxy-containing polysiloxane compounds represented by the Formulas (19) or (21) contains epoxy groups of an average of less than 2% by weight: 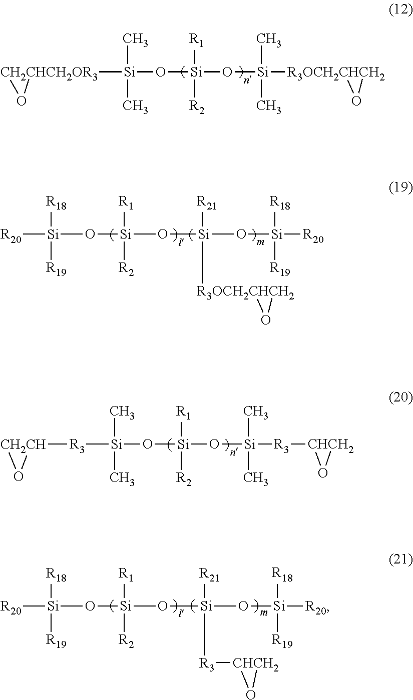
wherein in Formula (12), (19), (20) or (21), R₁, R₂ and R₁₈-R₂₁ represent independently an alkyl group, an alkenyl group, an aryl group, an aralkyl group, an alkylaryl group having 1-18 carbon atoms, or —(CH₂)_{α}—NH—C₆H₅ (α represents an integer of 1-8), wherein they may be entirely or partially substituted with halogen atoms; R₃ represents a divalent organic group; l′ and n′ are an integer greater than or equal to 0; and m is an integer greater than 0.

8. A molded produce obtained by using at least one selected from the polysiloxane modified polylactic acid resin composition according to claim 4.

9. A molded product obtained by using at least one selected from the polysiloxane-modified polylactic acid resin composition according to claim 5.
